(19) United States
(12) Patent Application Publication
(10) Pub. No.: US 2025/0131657 A1
(43) Pub. Date: Apr. 24, 2025

(54) ELECTRONIC DEVICE FOR PROVIDING USER-CUSTOMIZED METAVERSE CONTENT AND CONTROL METHOD THEREFOR

(71) Applicant: Samsung Electronics Co., Ltd., Suwon-si (KR)

(72) Inventors: Jeongmin KIM, Suwon-si (KR); Daehee PARK, Suwon-si (KR); Jinki JUNG, Suwon-si (KR); Saeimi CHOI, Suwon-si (KR)

(21) Appl. No.: 18/999,425

(22) Filed: Dec. 23, 2024

Related U.S. Application Data
(63) Continuation of application No. PCT/KR2023/011275, filed on Aug. 1, 2023.

(30) Foreign Application Priority Data
Aug. 18, 2022 (KR) 10-2022-0103575

(51) Int. Cl. G06T 19/00; G06F 40/30

(52) U.S. Cl. CPC G06T 19/00; G06F 40/30; G06T 2200/24

(57) ABSTRACT

The present disclosure provides an electronic device and a control method therefor. The electronic device according to an embodiment of the present disclosure includes: memory for storing a plurality of images; and at least one processor, comprising processing circuitry, individually and/or collectively, configured to: generate a content to be displayed in a virtual space of metaverse using the plurality of images, select a plurality of images corresponding to a user location from among the plurality of images; obtain an object keyword included in each of the selected plurality of images; determine an object to be reflected onto the virtual space of the metaverse based on a frequency of the object keyword obtained through each of the selected plurality of images; and generate an object content corresponding to the determined object.

### CROSS-REFERENCE TO RELATED APPLICATIONS

This application is a continuation of International Application No. PCT/KR2023/011275 designating the United States, filed on Aug. 1, 2023, in the Korean Intellectual Property Receiving Office and claiming priority to Korean Patent Application No. 10-2022-0103575, filed on Aug. 18, 2022, in the Korean Intellectual Property Office, the disclosures of each of which are incorporated by reference herein in their entireties.

### BACKGROUND

### Field

The disclosure relates to an electronic device for providing a metaverse content and a control method therefor, and for example, to an electronic device for generating a content to be displayed on a virtual space of the metaverse in a user-customized method.

### Description of Related Art

Recently, thanks to development of electronic technologies, rendering of 3-dimensional images of a virtual space close to a real world has become possible and receiving/transmitting of massive data between electronic devices has become possible. It has been followed by technical development of the metaverse, by which many users connect to the virtual space in real time to communicate with one another.

In particular, as the movement of the users and direct interactions between the users has been restricted due to the recent pandemic caused by COVID-19, the virtual space of the metaverse has received attention as an alternative to the real world. Due to technical development of the metaverse, many users in the virtual space of the metaverse have been able to perform social and cultural activities in the virtual space of the metaverse, beyond simple interactions such as conversations and chats between users, and have been even able to create economic value.

Meanwhile, in the case of the most existing metaverse services, many users could connect to or enter into the virtual space generated by a platform, a company, or the like providing the metaverse services and could perform interactions. In other words, many users had no choice but to perform interactions in the same virtual space. As a result, information or goods to be shared by the users in the virtual space were limited and fixed.

### SUMMARY

Embodiments of the disclosure provide an electronic device that provides a user-customized metaverse content and a controlling method therefor.

An electronic device according to an example embodiment of the disclosure includes: memory storing a plurality of images, and at least one processor, comprising processing circuitry, individually and/or collectively, configured to: generate a content to be displayed in a virtual space of the metaverse using the plurality of images, wherein at least one processor, individually and/or collectively, is configured to: select a plurality of images corresponding to a user position among the plurality of images, obtain an object keyword included in each of the selected plurality of images, determine an object to be reflected on the virtual space of the metaverse based on a frequency of the object keyword obtained through each of the selected plurality of images, and generate an object content corresponding to the determined object.

At least one processor, individually and/or collectively, may be configured to: identify a frequency of each of the obtained object keywords, select a plurality of first object keywords in which the identified frequency is equal to or greater than a specified value among the plurality of object keywords and determine an object to be reflected on the virtual space of the metaverse based on the selected plurality of first object keywords.

At least one processor, individually and/or collectively, may be configured to: identify semantic similarity between the user position and the plurality of first object keywords, select second object keywords having semantic similarity in which the identified semantic similarity is equal to or greater a specified value than among the plurality of first object keywords, and based on the selected second object keywords, determine an object to be reflected on the virtual space of the metaverse.

At least one processor, individually and/or collectively, may be configured to: identify the number of object keywords corresponding to each image, identify a frequency of the object keywords based on the number of the identified object keywords, and based on a plurality of keywords corresponding to one image including the same object keywords in multiple times, identify the number of the same object keywords with respect to the one image as one.

At least one processor, individually and/or collectively, may be configured to: identify whether the user position is a specified position, based on the user position being identified not to be in the specified position, obtain a background keyword of each of the selected plurality of images, determine a background to be reflected on the virtual space of the metaverse based on a frequency of the background keyword corresponding to each of the selected plurality of images, and generate a background content corresponding to the determined background and object contents corresponding to the determined object.

At least one processor, individually and/or collectively, may be configured to: identify a plurality of texts obtained for a period corresponding to the user position, obtain a plurality of emotion keywords corresponding to the identified plurality of texts, and determine a background to be reflected on the virtual space of the metaverse based on the obtained emotion keywords and the user position.

The electronic device may further include: a display, wherein at least one processor, individually and/or collectively, may be configured to control the electronic device to: transmit the object content to a server, receive a virtual space image including the object content from the server, and display the received virtual space image.

At least one processor, individually and/or collectively, may be configured to control the display to display a UI to display at least one image corresponding to the object content at positions corresponding to the object content within the virtual space image.

At least one processor, individually and/or collectively, may be configured to: identify whether the number of a plurality of images corresponding to the user position among the plurality of images is equal to or greater than the specified number, and based on the number of the plurality of images corresponding to the user position being equal to or greater than the specified number, obtain an object keyword included in each of the selected plurality of images.

At least one processor, individually and/or collectively, may be configured to sense the user position in real time, and based on the user position being sensed as being changed from a first position to a second position, select a plurality of images corresponding to the first position among the plurality of images.

According to an example embodiment of the disclosure, a method of controlling the electronic device includes: selecting a plurality of images corresponding to a user position among a plurality of images, obtaining an object keyword included in each of the selected plurality of images, determining an object to be reflected on a virtual space of metaverse based on a frequency of the object keyword obtained through each of the selected plurality of images, and generating an object content corresponding to the determined object.

The determining may include: identifying a frequency of each of the obtained object keywords and selecting a plurality of first object keywords in which the identified frequency are equal to or greater than a specified value among the plurality of object keywords, and determining an object to be reflected on the virtual space of the metaverse based on the selected plurality of first object keywords.

The determining may include: identifying semantic similarity between the user position and the plurality of first object keywords, selecting second object keywords having semantic similarity in which the identified semantic similarity is equal to or greater than a specified value among the plurality of first object keywords, and determining an object to be reflected on the virtual space of the metaverse based on the selected second object keywords.

The determining may include: identifying the number of object keywords corresponding to each image, identify a frequency of the object keywords based on the number of the identified object keywords, and based on a plurality of keywords corresponding to one image including the same object keywords in multiple times, identify the number of the same object keywords with respect to the one image as one.

The method may include: identifying whether the user position is a specified position, based on the user position being identified not to be in the specified position, obtain a background keyword of each of the selected plurality of images, determining a background to be reflected on the virtual space of the metaverse based on a frequency of the background keyword corresponding to each of the selected plurality of images, and the generating includes generating a background content corresponding to the determined background and an object content corresponding to the determined object.

The method may further include: identifying at least one text obtained for a period corresponding to the user position, obtaining emotion keywords corresponding to the identified at least one text, and determining a background to be reflected on the virtual space of the metaverse based on the obtained emotion keyword and the user position.

The method may further include: transmitting the object content to a server, receiving a virtual space image including the object content from the server, and displaying the received virtual space image.

The method may further include: displaying a UI to display at least one image corresponding to the object content at positions corresponding to the object content within the virtual space image.

The obtaining the object keywords may include: identifying whether the number of the selected plurality of images is equal to or greater than the specified number, and based on the number of the plurality of images corresponding to the user position being equal to or greater than the specified number, obtaining an object keyword included in each of the selected plurality of images.

The selecting may include: sensing the user position in real time, and based on the user position being sensed as being changed from a first position to a second position, selecting a plurality of images corresponding to the first position among the plurality of images.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a diagram illustrating an example method of operating an electronic device according to various embodiments;

FIG. 2 is a block diagram illustrating an example configuration of an electronic device according to various embodiments;

FIG. 3 is a diagram illustrating an example method of selecting a plurality of images corresponding to a user position according to various embodiments;

FIG. 4 is diagram illustrating a plurality of object keywords obtained with respect to a plurality of images corresponding to a user position using a first neural network model and a frequency of the obtained plurality of object keywords according to various embodiments;

FIG. 5 is a diagram illustrating selecting first object keywords among a plurality of object keywords based on a frequency of the plurality of object keywords according to various embodiments;

FIG. 6 is a diagram illustrating an example method of selecting second object keywords among a plurality of first object keywords based on semantic similarity between the object keywords and the user position according to various embodiments;

FIG. 7 is a diagram illustrating an example method of identifying a frequency with respect to each object keyword in the case that the same object keywords among a plurality of object keywords corresponding to one image are included in multiple times according to various embodiments;

FIG. 8 is a diagram illustrating an example method of generating a background content by inputting a plurality of images corresponding to a user position into a second neural network model if the user position is identified as being not the preset position according to various embodiments;

FIG. 9 is a diagram illustrating an example of generating a background content based on a frequency of a plurality of background keywords according to various embodiments;

FIG. 10 is a diagram illustrating an example of obtaining a plurality of emotion keywords corresponding to a plurality of texts obtained for a period corresponding to a user position based on a third neural network model according to various embodiments;

FIG. 11 is a diagram illustrating an example of generating a background content based on a frequency of a plurality of emotion keywords according to various embodiments;

FIG. 12 is a diagram illustrating an example UI for displaying at least one image corresponding to an object content according to various embodiments;

FIG. 13 is a block diagram illustrating an example configuration of an electronic device according to various embodiments;

FIG. 14 is a flowchart illustrating an example control method of an electronic device according to various embodiments;

FIG. 15 is a signal flow diagram illustrating an example method in which an electronic device operates as a user terminal device according to various embodiments; and

FIG. 16 is a signal flow diagram illustrating an example method in which an electronic device operates as a server according to various embodiments.

### DETAILED DESCRIPTION

The terms used in describing various example embodiments of the disclosure are selected as general terms which are currently widely used as much as possible in consideration of functions in the disclosure. However, it may be varied depending on intention of those skilled in the art or a precedent, appearance of new technologies, or the like. Certain terms may be arbitrarily selected. In this case, its meaning is described in the relevant part of the disclosure. Therefore, the terms used in the disclosure are to be defined based not simply on the name of the term but the meaning of the term and the description throughout the entire content of the disclosure.

In this disclosure, expressions such as “have,” “may have,” “include” or “may include” denote the existence of such characteristics (e.g. elements such as numerical values, functions, operations, and parts), and the expressions do not exclude the existence of additional characteristics.

The expression “at least one of A and/or B” may refer, for example, to any one of “A” or “B” or “A and B.”

The expressions “1st”, “2nd”, “first”, “second”, or the like used in this disclosure may be used to describe various elements regardless of any order and/or degree of importance. Also, such expressions are used simply to distinguish one element from another element and are not intended to limit the elements.

Singular expressions include plural expressions, unless defined differently in the context. In the application, terms such as “include” or “consist of” should be construed as designating that there are such characteristics, numbers, steps, operations, elements, parts, or a combination thereof described in the disclosure, but not as excluding in advance the existence or possibility of adding one or more other characteristics, numbers, steps, operations, elements, parts, or a combination thereof.

In the disclosure, the term ‘user’ may refer to a person using an electronic device or a device (e.g. an artificial intelligence (AI) electronic device) using the electronic device.

Hereinafter, various example embodiments of the disclosure are described in greater detail with reference to the appended drawings.

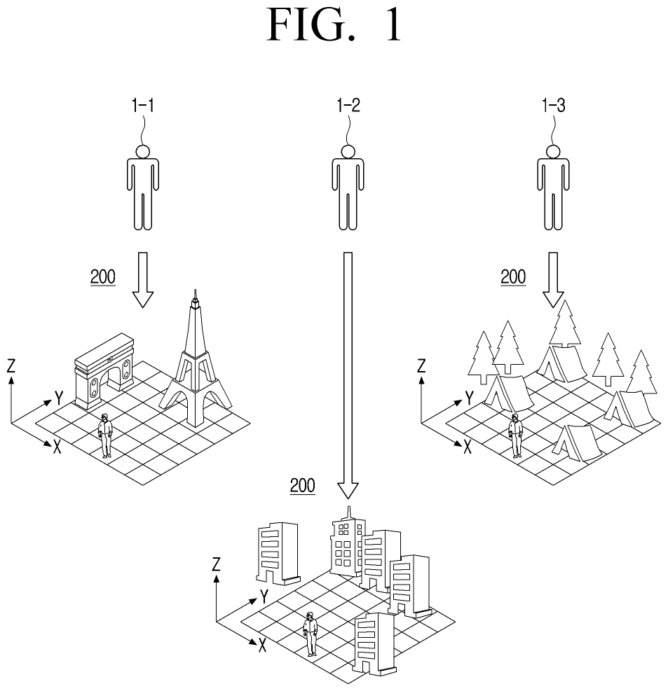

FIG. 1 is a diagram illustrating an example method of operating an electronic device according to various embodiments.

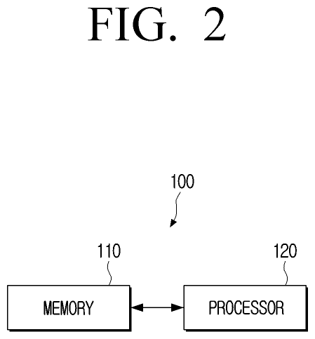

An electronic device 100 (e.g., refer to FIG. 2) of the disclosure is a device generating a content to be displayed in a virtual space 200 of metaverse, wherein it may include, for example, at least one of a TV, a smart phone, a tablet PC, a desktop PC, a notebook PC but is not limited thereto. The disclosure is not limited thereto and the electronic device 100 may include a server in various forms of a cloud server, an embedded server, or the like.

According to the disclosure, the electronic device 100 provides a content to be reflected in the virtual space 200 of user-customized metaverse. For example, an object to be reflected in the virtual space 200 of the metaverse is generated by utilizing a plurality of images 10 stored in the electronic device 100. For example, the plurality of images 10 stored in the electronic device 100 are directly obtained by users or received and stored from another user (or another electronic device). Accordingly, the plurality of images 10 stored in each electronic device 100 may be unique and different for every user of the electronic device 100. Therefore, the electronic device 100 according to an embodiment of the disclosure generates a content to be reflected in the virtual space 200 of the metaverse based on the plurality of images 10 stored in the electronic device 100, thereby providing every user with a different and unique metaverse content.

This is different from the related art in which a plurality of users enter into the virtual space 200 of the same metaverse and perform interactions. In particular, in the case of the virtual space 200 of the same metaverse, information provided through the virtual space is the same with respect to the plurality of users and thus interactions performed by the plurality of users are to be limited. However, since the disclosure provides the unique virtual space 200 of the metaverse generated based on images (more specifically, images stored in the electronic device of each user) of each user 1-1, 1-2, and 1-3, a content or information received or obtained by the users are various.

Hereinafter, various example embodiments of the disclosure related to the above are described in greater detail.

FIG. 2 is a block diagram illustrating an example configuration of an electronic device according to various embodiments.

According to FIG. 2, the electronic device 100 includes memory 110 and a processor (e.g., including processing circuitry) 120.

The memory 110 may store data required for various embodiments of the disclosure. The memory 110 may be implemented as memory embedded in the electronic device 100 or may be implemented as memory capable of performing communication with (or a detachable from) the electronic device 100 depending on the data storage purpose. For example, data for driving the electronic device 100 may be stored in memory embedded in the electronic device 100 and data for an extension function of the electronic device 100 may be stored in memory capable of performing communication with the electronic device 100.

The memory embedded in the electronic device 100 may be implemented as at least one of volatile memory (e.g. dynamic RAM (DRAM), static RAM (SRAM), or synchronous dynamic RAM (SDRAM), etc.), non-volatile memory (e.g. one time programmable ROM (OTPROM), programmable ROM (PROM), erasable and programmable ROM (EPROM), electrically erasable and programmable ROM (EEPROM), mask ROM, and flash ROM), flash memory (e.g. NAND flash, NOR flash, etc.), a hard drive, or a solid state drive (SSD). Also, memory 110 capable of performing communication with the electronic device 100 may be implemented as a memory card (e.g. a compact flash (CF) card, a secure digital (SD) card, a micro secure digital (Micro-SD) card, a mini secure digital (Mini-SD) card, an extreme digital (xD) card, a multi-media card (MMC), etc.), external memory connectable to a USB port (e.g. USB memory 110), etc.

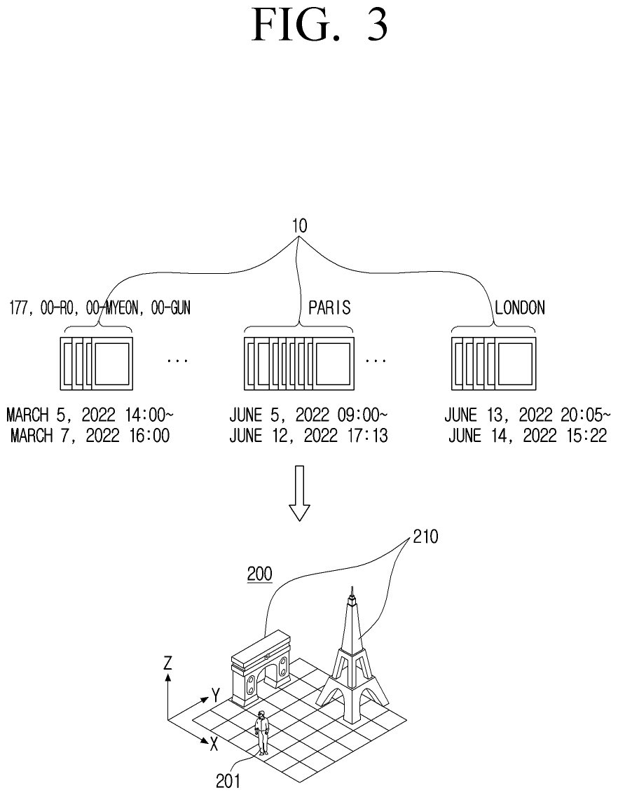

According to an embodiment of the disclosure, a plurality of images 10 (e.g., refer to FIG. 3) may be stored in the memory 110. The plurality of images 10 may include images obtained through a camera included in the electronic device 100, images obtained by capturing a web page based on a user command input through an input interface included in the electronic device 100, an image received and obtained from another electronic device through a communication interface, or the like. As such, the memory 110 may store the plurality of images 10 obtained through various forms and various paths.

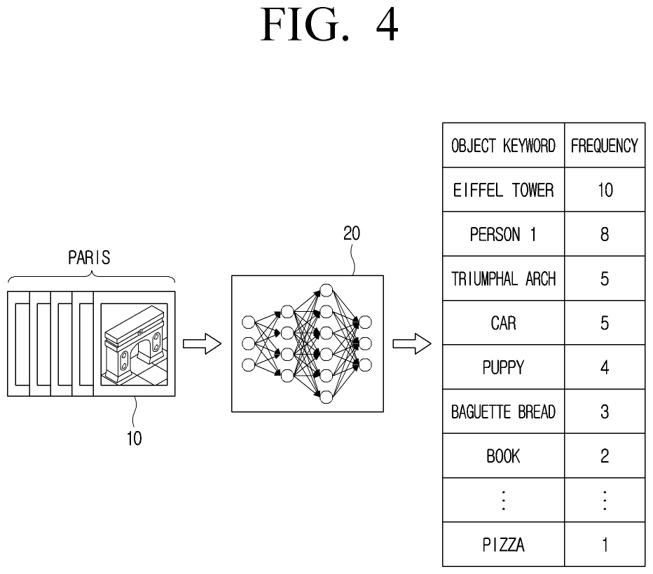

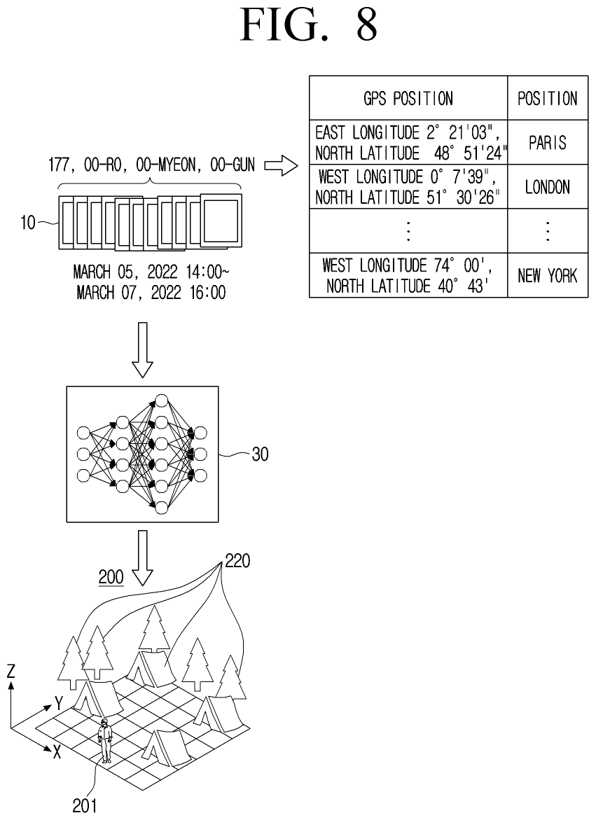

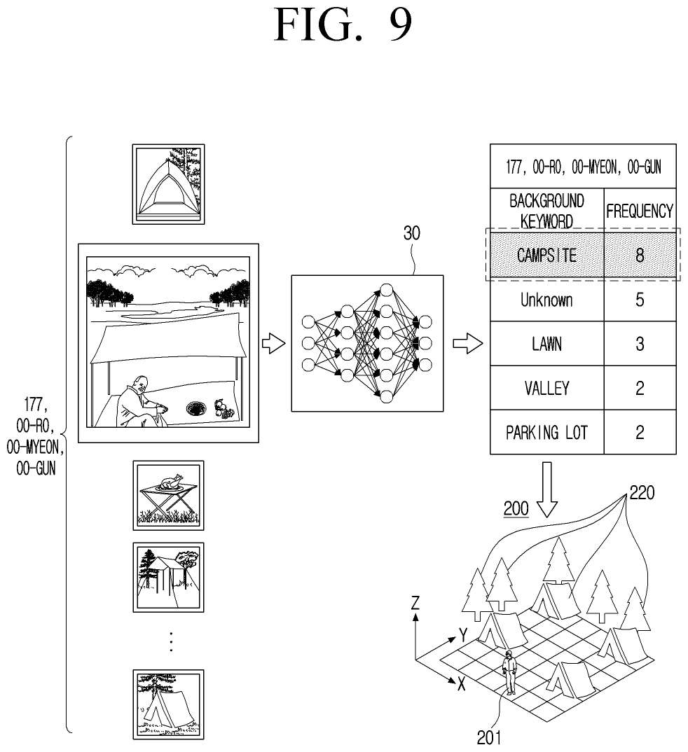

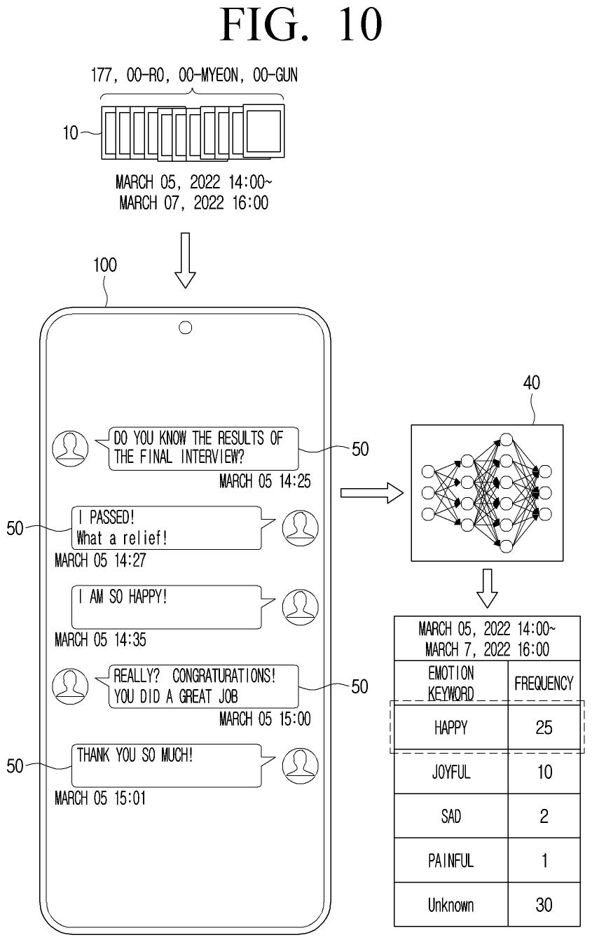

According to an embodiment of the disclosure, the memory 110 may store a plurality of neural network models. As an example, the memory 110 may store a neural network model 20 (e.g., refer to FIG. 4) to detect an object included in an image, a neural network model 30 (e.g., refer to FIGS. 8 and 9) for identifying a background in an image, and a neural network model 40 (e.g., refer to FIG. 10) identifying an emotion corresponding to a text. According to an embodiment of the disclosure, the memory 110 may store content information generated based on the plurality of neural network models. The various modules may include various circuitry and/or executable program instructions.

The processor 120 may include various processing circuitry and is configured to control operations of the electronic device 100 overall. For example, the processor 120 may connect to each component of the electronic device 100 to control operations of the electronic device 100 overall. For example, the processor 120 may connect to a component such as memory 110, a camera, or a communication interface to control operations of the electronic device 100.

According to an embodiment, the processor 120 may be implemented as a digital signal processor (DSP), a microprocessor, or a Time controller (TCON). The disclosure is not limited thereto and it may include at least one of a central processing unit (CPU)), a micro controller unit (MCU), a micro processing unit (MPU), a controller, an application processor (AP), or a communication processor (CP), and an ARM processor or may be defined by the relevant terms. Also, the processor 120 may be implemented as a system on chip (SoC) in which processing algorism is embedded or a large scale integration (LSI) and may be implemented as a field programmable gate array (FPGA).

The processor 120 for implementing a neural network (or an AI model) according to an embodiment may be implemented by combinations of a general purpose processor such as the CPU, the AP, and a digital signal processor (DSP), an a graphic dedicated processor 120 such as a GPU and a vision processing unit (VPU), or AI dedicated processor such as a NPU with software. The processor 120 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The processor 120 may control to process input data according to the operation rule predefined in the memory 110 or the AI model. If the processor 120 is a dedicated processor (or an AI dedicated processor), it may be designed in a hardware structure specific to processing of a specific AI model. For example, the hardware specific to processing of the specific AI model may be designed as a hardware chip such as an ASIC and the FPGA. If the processor 120 is implemented as a dedicated processor, it may be realized to include memory to implement an embodiment of the disclosure or may be realized to include a memory processing function for using the external memory.

FIG. 3 is a view for diagram illustrating an example method of selecting a plurality of images corresponding to a user position according to various embodiments.

The processor 120 according to an embodiment of the disclosure selects a plurality of images 10 corresponding to a user position among the plurality of images 10 stored in the memory 110.

Specifically, the processor 120 may classify the plurality of images 10 stored in the memory 110 according to each user position.

Here, the plurality of images 10 corresponding to the user position may be images stored in the memory 110 after obtained while the user is in a specific position. For example, the images may be images stored in the memory 110 after obtained by the user through a camera at a specific position or may be images stored in the memory 110 after received from another electronic device 100 through the communication interface while the user is in the specific position.

For example, if the user position is Paris, the plurality of images 10 corresponding to the user position may include photos captured and stored through a camera while the user is located in Paris, images obtained and stored through a messenger or a social network service (SNS), images captured and stored on a web page, or the like.

The processor 120 may identify the user position based on GPS coordinates of the electronic device 100 obtained from a GPS sensor included in the electronic device 100. Accordingly, the processor 120 may identify a change of the user position whenever the GPS coordinates of the electronic device 100 change. If the change of the user position is identified, the processor 120, may select a plurality of images 10 corresponding to the user position before the change among the plurality of images 10 stored in the memory 110.

For example, it is assumed that the processor 120 identifies that the user position is changed from Paris (a first position) to London (a second position) based on the GPS coordinates of the electronic device 100 obtained through the GPS sensor of the electronic device 100. Here, the processor 120 may classify and identify the plurality of images 10 stored before the user position is changed to London (the second position) as the plurality of images 10 corresponding to Paris (the first position) and may classify and identify the plurality of images 10 stored in the memory 110 after the user position is changed to London (the second position) as the plurality of images 10 corresponding to London (the second position). As such, the processor 120 may classify the plurality of images 10 stored in the memory 110 in response to the user position whenever the user position is changed.

The processor 120, if the user position is changed, may identify that the user position is the same even though identifying that the user position is changed within the preset radius in a center of the changed user position. For example, the processor 120, after identifying that the user position is changed from the third position to the fourth position, may identify the user position as a fourth position even though the user position is changed within the preset radius (e.g. 10 km) at the fourth position.

The disclosure is not limited thereto and criteria and ranges in the change of the user position may be set in various methods. For example, the processor 120 may also identify that the user position is changed whenever a city (or a town, a county, etc.) to which the user position belongs is changed based on GPS information.

The memory 110 may store a plurality of images 10 as a data set according to the user position. For example, with reference to FIG. 3, a plurality of images 10 obtained while the user is located in Paris may be stored as a data set. Also, a plurality of images 10 obtained while the user is located in London may be stored as a data set. Otherwise, a plurality of images 10 obtained while the user is located at “177, OO-ro, OO-myeon, OO-gun” may be stored as a data set.

As such, the processor 120 may classify a plurality of images 10 stored in the memory 110 according to the user position.

The processor 120 may identify time corresponding to each user position together with an image corresponding to each user position. The time corresponding to each user position may be a period when the user is present in a specific position. The processor 120 may identify a time point when the user position is changed, a period when the user stays at a changed position, and a time point when the user position is changed again, thereby identifying time corresponding to the user position. Also, time corresponding to the user position may be identified based on metadata included in each image.

For example, with reference to FIG. 3, the processor 120 may identify a period when the user stays in Paris based on metadata included in an initial image obtained and stored in Paris and metadata included in the last image obtained and stored in Paris. Here, according to FIG. 3, the processor 120 identifies a period corresponding to Paris as “Jun. 5, 2022 09:00˜Jun. 12, 2022 17:13”.

The processor 120 may obtain an object content 210 to be reflected on the virtual space 200 of the metaverse based on a plurality of images 10 selected to correspond to the user position. For example, the processor 120 may obtain an object keyword from the plurality of images 10 and may generate an object content 210 corresponding to the obtained object keyword. Further, the processor 120 may display the generated object content 210 on the virtual space 200 of the metaverse.

For example, with reference to FIG. 3, the processor 120 may obtain object keywords “Eiffel Tower” and “Triumphal Arch” from a plurality of images 10 corresponding to the user position, Paris. Further, the processor 120 may generate an object content 210 corresponding to obtained object keywords “Eiffel Tower” and “Triumphal Arch”, respectively.

The object content 210 may be 3-dimensional object images reflected on the virtual space 200 of the metaverse. For example, the object content 210 may be 3-dimensional images about a person, an animal, food, an object, and the like displayed on the virtual space 200 of the metaverse. In other words, with reference to FIG. 3, the processor 120 may generate 3-dimensional images about “Eiffel Tower” and “Triumphal Arch” based on the object content 210 and may dispose the generated 3-dimensional images of “Eiffel Tower” and “Triumphal Arch” at the preset position in the virtual space 200 of the metaverse.

The preset (e.g., specified) user content 201 may be reflected together on the virtual space 200 of the metaverse. The user content 201 may be generated by a user setting based on a graphic object indicating the user. For example, the processor 120 may generate the user content of the 3-dimensional images based on a face, a body shape, a height, a weight, clothes, shoes, and the like of the user content 201 input or set by the user through the input interface.

According to an embodiment of the disclosure, the processor 120 may sense the user position in real time, and based on the user position being sensed as being changed from a first position to a second position, select a plurality of images corresponding to the first position among the plurality of images.

For example, the processor 120 may sense the real time position of the user based on GPS information. The processor 120, if it is identified that the real time position of the user is changed, may select a plurality of images 10 corresponding to the user position before changing among the plurality of images 10 stored in the memory 110 and may generate a virtual content (e.g. a virtual object content) to be reflected on the virtual space 200 of the metaverse based on the selected plurality of images 10. In other words, whenever the user position is changed, the processor may obtain object keywords through a plurality of images 10 corresponding to the user position before changing and may generate a virtual content to be reflected on the virtual space 200 based on the obtained object keywords.

For example, if it is sensed that the real time position of the user is changed from the first position to the second position, the processor 120 may select a plurality of images corresponding to a first position among a plurality of images stored in the memory 110. Further, the processor 120 may obtain object keywords through a plurality of images corresponding to the first position and may generate an object content corresponding to the obtained object keywords. Here, the generated object keywords do not relate to the real time position of the user, the second position, and may relate to the first position corresponding to the user position before changing.

Hereinafter, according to various example embodiments of the disclosure, a method of creating the object content 210 is described in greater detail.

FIG. 4 is for a diagram illustrating a plurality of object keywords obtained with respect to a plurality of images 10 corresponding to a user position using a first neural network model and a frequency of the obtained plurality of object keywords according to various embodiments.

According to an embodiment of the disclosure, the processor 120 obtains object keywords included in each of the selected plurality of images 10.

For example, the processor 120 may obtain object keywords related to objects included in each image. The object keywords may include keywords indicating a type, a color, a position, a gender of the objects, and the like. The processor 120 may obtain object keywords after identifying whether objects are included in each image and identifying a type, a color, and the like of the identified objects. Here, the processor 120 may obtain object keywords based on an object-object keyword matching table stored in the memory 110. The object-object keyword matching table may refer, for example, to a table storing at least one object keyword matching each object. Accordingly, the processor may identify a type of an object in the selected image and may obtain an object keyword matching the type of the identified object from the object-object keyword matching table.

According to an embodiment of the disclosure, the processor may use a neural network model for obtaining an object keyword related to an object in the selected image. In other words, the processor 120 may use a neural network model 20 detecting an object included in the image to obtain an object keyword included in each of the plurality of images 10.

The neural network model 20 detecting an object included in the image may be a neural network model trained to detect an object included in the input image, identifying a type of the detected object, and outputting a keyword about a type of the identified object.

For the above, the neural network model 20 detecting an object included in the image may be a neural network model pre-trained based on learning data including a plurality of images 10 including an object. The neural network model 20 detecting an object included in the image may be implemented, for example, and without limitation, as a convolutional neural network (CNN) model, a fully convolutional networks (FCN) model, a regions with convolutional neuron networks features (RCNN) model, a YOLO model, etc. Hereinafter, for convenience of the description, the neural network model 20 detecting an object included in the image according to an embodiment of the disclosure is described and referred to as a first neural network model 20.

The processor 120 may input a plurality of images 10 selected to correspond to the user position into the first neural network model 20 and may obtain an object keyword corresponding to an object detected from each image. The object keyword may be a keyword indicating a type, a kind, and the like of the detected object.

For example, with reference to FIG. 4, the processor 120 identifies the user position as Paris and selects a plurality of images 10 corresponding to the identified Paris among the plurality of images 10 stored in the memory 110. Further, the processor 120 may input the selected plurality of images 10 into the first neural network model 20 and may obtain an object keyword corresponding to an object included in each image. With reference to FIG. 3, the processor 120 has the object keywords obtained through the plurality of images 10 corresponding to Paris, “Eiffel Tower”, “person 1”, “Triumphal Arch”, “car”, “puppy”, etc.

According to an embodiment of the disclosure, the processor 120 may identify whether the number of a plurality of images 10 corresponding to the user position among the plurality of images 10 is equal to or greater than the preset number and if the number of the plurality of images 10 corresponding to the user position is equal to or greater than the preset number, may obtain an object keyword included in each of the selected plurality of images 10 using the first neural network model 20.

For example, the processor 120 may identify whether the user position corresponding to the plurality of images 10 is a meaningful place to the user. For the above, the processor 120 may identify whether the number of the plurality of images 10 corresponding to each user position is equal to or greater than the preset number and may determine to generate an object content 210 to be reflected on the virtual space 200 of the metaverse only with respect to the user position where the number of the plurality of images 10 is equal to or greater than the preset number. Again, if the user stores many images while being in a specific position (or place), the processor 120 may identify that the specific position (or the place) is a meaningful or important position (or place) to the user and may determine that the specific position is realized in the virtual space 200 of the metaverse.

The processor 120 may identify whether there is sufficient data to realize a virtual content composing the virtual space 200 of the metaverse based on the number of the plurality of images 10 corresponding to the user position. The object content 210 reflected on the virtual space 200 of the metaverse are generated based on the plurality of images 10 stored in the memory 110 without a separate user input or data reception. This may refer, for example, to the user receiving a service in which the specific position is realized in the virtual space 200 of the metaverse only by storing an image obtained through a camera and an image received through a messenger, etc. In other words, the user may experience a content about a position and a place where the user stays in the virtual space 200 of the metaverse without separate work for realizing the virtual space 200 of the metaverse of the user.

For the above, sufficient data for generating an object content 210 to be displayed on the virtual space 200 of the metaverse is needed. Therefore, the processor 120 may identify the number of the plurality of images 10 corresponding to each user position and may generate an object content 210 to be reflected on the virtual space 200 of the metaverse only with respect to the user position where the number of the plurality of images 10 is equal to or greater than the preset number.

When it is identified that the number of the plurality of images 10 is equal to or greater than the preset number, the processor 120 may input each of the plurality of images 10 into the first neural network model 20 to obtain a plurality of object keywords. The above is explained in the aforementioned description and thus the detailed description is omitted.

According to an embodiment of the disclosure, the processor 120 determines an object to be reflected on the virtual space 200 of the metaverse based on a frequency of the object keywords obtained through each of the selected plurality of images 10.

The frequency of the object keywords may be an accumulated number of the object keywords obtained by the processor 120 with respect to the user position when the plurality of images 10 selected to correspond to the user position are sequentially input into the first neural network model 20.

For example, the processor 120 may input each of the plurality of images 10 selected to correspond to the user position into the first neural network model 20 and may obtain at least one object keyword corresponding to each image. For example, the processor 120 may not obtain an object keyword through the first neural network model 20 with respect to an image which does not include an object. Otherwise, the processor 120 may obtain a plurality of keywords corresponding to a plurality of objects with respect to images including a plurality of objects. The processor 120 may identify the accumulated number of the object keywords obtained with respect to each image.

For example, with reference to FIG. 4, the processor 120 may input each of the plurality of images 10 corresponding to the user position, Paris into the first neural network model 20 and may identify the accumulated number of the object keywords obtained whenever an object keyword is obtained. According to FIG. 3, the processor 120 identifies the accumulated number of the object keyword “Eiffel Tower” as 10. Further, the processor 120 identifies the accumulated number of the object keyword “person 1” as 8. As such, the processor 120 may identify the accumulated number of each of the object keywords obtained whenever each object keyword is obtained, thereby identifying a frequency of each keyword.

Further, the processor 120 may identify the object keyword having a high frequency such that the user repetitively obtains and stores an image related to an object corresponding to the object keyword. Still further, the processor 120 may identify an object of which an image is repetitively obtained by the user as high relevance with the user position. In other words, the processor 120 may identify the relevant object as being meaningfully related to the user position.

Again, with reference to FIG. 4, it is identified that “Eiffel Tower” has the highest frequency among a plurality of object keywords obtained from the plurality of images 10 corresponding to “Paris”. The processor 120 may identify that “Eiffel Tower” is a meaningful object or an important object related to “Paris” to the user. Further, the processor 120 may determine to generate an object content 210 related to “Eiffel Tower”. The fact that the user stores many images related to “Eiffel Tower” while being in “Paris” may refer, for example, to the user having good memories related to “Eiffel Tower” in “Paris”. Therefore, in realizing the virtual space 200 of the metaverse related to “Paris”, the processor 120 may generate a content of “Eiffel Tower” and incorporate the generated content of “Eiffel Tower” into the virtual space, thereby showing an effect of reminding the user of good memories related to Paris.

According to an embodiment of the disclosure, the processor 120, after determining an object to be reflected on the virtual space 200 of the metaverse, generates an object content 210 corresponding to the determined object.

For example, a 3-dimensional image corresponding to the determined object may be rendered. The memory 110 may store a 3-dimensional object image (or a program generating a 3-dimensional object image) corresponding to each object keyword or each object. Accordingly, the processor 120 may obtain the 3-dimensional object image corresponding to the determined object from the memory 110 and may display the obtained 3-dimensional object image on the virtual space 200 of the metaverse. Otherwise, the processor 120 may transmit an object keyword obtained through a communication part to an external device (e.g. an external server) and may obtain a 3-dimensional object image corresponding to the object keyword from the external device through the communication part.

According to an embodiment of the disclosure, the processor 120 may identify a frequency of each of the obtained object keyword and may select at least one object keyword of which the identified frequency is equal to or greater than among the plurality of object keywords. Further, the processor 120 may determine an object to be reflected on the virtual space 200 of the metaverse based on the selected at least one object keyword.

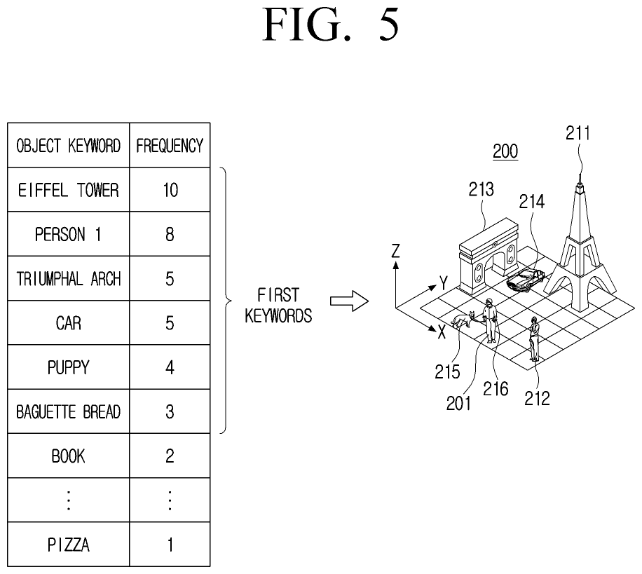

FIG. 5 is for a diagram illustrating an example of selecting first object keywords among a plurality of object keywords based on a frequency of the plurality of object keywords according to various embodiments.

For example, the processor 120 may identify a frequency of each object keyword obtained through a plurality of images 10 corresponding to the user position. In other words, the processor 120 may identify the accumulated number of each of the obtained object keywords. Further, the processor 120 may identify an object keyword of which the obtained accumulated number is equal to or greater than among the entire object keywords obtained through the plurality of images 10. Still further, the processor 120 may generate an object content 210 corresponding to the object keyword of which the obtained accumulated number is equal to or greater than.

If the processor 120 generates an object content 210 corresponding to each object keyword using all of the object keywords obtained through the plurality of images 10, it may take long time and may consume many resources of the electronic device 100. Therefore, the processor 120 may select only an object keyword which is meaningful to the user among a plurality of object keywords and may generate an object content 210 corresponding to the selected object keyword. Hereinafter, the object keyword of which a frequency is equal to or greater than among the entire object keywords may be referred to as the first object keywords.

For example, with reference to FIG. 5, if it is assumed that the preset value selecting the first object keywords is 2, an object keyword having a frequency of the preset value or more is “Eiffel Tower”, “person 1”, “Triumphal Arch”, “car”, “puppy”, and “baguette bread” among the plurality of object keywords. Accordingly, the processor 120 may select “Eiffel Tower”, “person 1”, “Triumphal Arch”, “car”, “puppy”, and “baguette bread” as the first object keywords among the plurality of object keywords corresponding to Paris. Further, the processor 120 may generate a 3-dimensional image 211 related to “Eiffel Tower”, a 3-dimensional image 212 related to “person 1”, a 3-dimensional image 213 related to “Triumphal Arch”, a 3-dimensional image 214 related to “car”, a 3-dimensional image 215 related to “puppy”, and a 3-dimensional image 216 related to “baguette bread” as an object content 210 corresponding to the selected first object keywords. Further, the processor 120 may display the generated plurality of object contents 210 on the virtual space 200 of the metaverse.

A position where each object content 210 is displayed may be preset according to a type of the object keyword. Also, a position where each object keyword is displayed on the virtual space 200 of the metaverse may be determined based on a position where each image is obtained and which is identified based on the metadata in the image from which each object keyword is obtained. It will be apparent that the position of each of object contents 210 displayed on the virtual space 200 of the metaverse may be changed by the user.

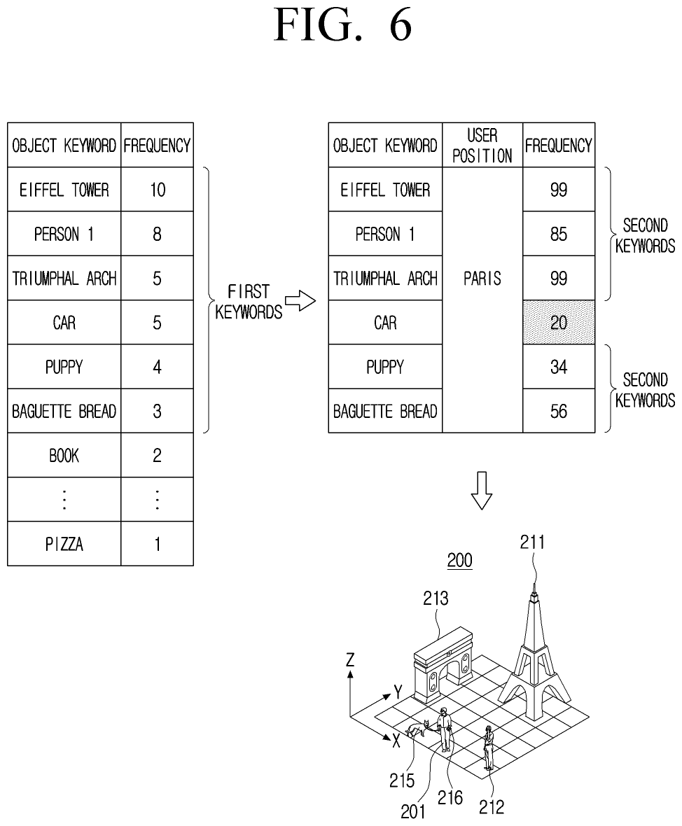

FIG. 6 is for a diagram illustrating an example method of selecting second object keywords among a plurality of first object keywords based on semantic similarity between the object keywords and the user position according to various embodiments.

According to an embodiment of the disclosure, the processor 120 may identify semantic similarity between the user position and a plurality of object keywords and may select at least one object keyword having semantic similarity in which the identified semantic similarity is equal to or greater than among the plurality of the first object keywords. Further, the processor 120 may determine an object to be reflected on the virtual space 200 of the metaverse based on the selected at least one object keyword.

For example, the processor 120 may select at least one object keyword which has high relevance with the user position among the plurality of first object keywords identified as being meaningfully related to the user position for the user. Hereinafter, the first object keywords having semantic similarity with the user position in the preset value or more among the first object keywords may be referred to as the second object keywords.

For example, the processor 120 may select the first object keywords meaningfully related to the user position for the user among the plurality of object keywords obtained based on a frequency of the object keywords. Meanwhile, the first object keyword is selected in a criterion how frequently an object keyword is obtained through the plurality of images 10 corresponding to the user position and thus a noise may be included among the plurality of first object keywords. The noise may be an object keyword incorrectly identified as being meaningfully related to the user position or an image corresponding to the incorrectly identified object keyword based on a frequency of the object keyword.

For example, it is assumed that the user receives a plurality of images 10 including a specific object from a specific counterpart through a messenger while the user is in Paris. If the user stores the received plurality of images 10 unintentionally or unconsciously, the plurality of images 10 including the specific object received through the messenger may be selected as a plurality of images 10 corresponding to Paris. This may result in the object keywords corresponding to the specific object being selected as the first object keywords. In other words, this result in the object keywords not meaningfully related to Paris where the user stays being selected as the first object keywords.

Therefore, according to an embodiment of the disclosure, the processor 120 may identify semantic similarity between the selected plurality of first object keywords and the user position and may select an object keyword having substantial relevance with the user position among the plurality of first object keywords based on the identified semantic similarity. For the above, the processor 120 may select the first object keywords having semantic similarity in which semantic similarity is equal to or greater than as second object keywords.

For example, the processor 120 may identify similarity between the first object keywords and a text 50 corresponding to the user position. Specifically, the processor 120 may obtain a vector respectively corresponding to the first object keywords and the user position, identify a cosine angle between each vector, and identify semantic similarity between the first object keywords and the user position based on the identified cosine angle. Otherwise, it may measure the Euclidean distance between each vector and may identify semantic similarity between the first object keywords and the user position based on the measured Euclidean distance. For the above, the processor 120 may use a neural network model trained to calculate semantic similarity between the first object keywords and the user position (or trained to calculate semantic similarity between texts 50). The neural network model calculating semantic similarity may include a Word2vec model, a CNN model, a natural language processing model, a bidirectional encoder representations from transformers model (e.g., a Bert model), etc.

The processor 120 may select the first object keywords having semantic similarity in which the identified semantic similarity is equal to or greater than among the plurality of first object keywords as second object keywords. For example, with reference to FIG. 6, the processor 120 may identify semantic similarity between the selected first object keywords (the Eiffel Tower, person 1, the Triumphal Arch, a car, a puppy, and baguette bread) and the user position (Paris). Here, if the preset value related to semantic similarity is 30, the processor 120 may select the other first object keywords excluding the car among the plurality of first object keywords as the second object keywords. In other words, the processor 120 identifies that Paris corresponding to the user position is not related to the car based on semantic similarity. Further, the processor 120 may identify that the Eiffel Tower, the person 1, the Triumphal Arch, the puppy, and the baguette bread selected as the second object keywords are highly related to Paris corresponding to the user position based on semantic similarity.

Further, according to an embodiment of the disclosure, the processor 120 may identify an object corresponding to the selected second object keywords and may generate an object content 210 corresponding to the identified object.

For example, the processor 120 may determine the selected second object keywords as an object to be reflected on the virtual space 200 of the metaverse. Further, the processor 120 may generate an object content 210 corresponding to the second object keywords. In other words, the processor 120 may render 3-dimensional object images corresponding to the second object keywords.

With reference to FIG. 6, the processor 120 is configured to generate a 3-dimensional image 211 related to “Eiffel Tower”, a 3-dimensional image 212 related to “person 1”, a 3-dimensional image 213 related to “Triumphal Arch”, a 3-dimensional image 215 related to “puppy”, and a 3-dimensional image 216 related to “baguette bread” as an object content 210 corresponding to the selected second object keywords and display the generated plurality of object contents 210 on the virtual space 200 of the metaverse about Paris. When comparing FIG. 5 to FIG. 6, a car content having low relevance with Paris is excluded from FIG. 6 based on semantic similarity.

According to an embodiment of the disclosure, the processor 120 may identify the number of object keywords corresponding to each image, identify a frequency of the object keywords based on the number of the identified object keywords, and based on a plurality of keywords corresponding to one image including the same object keywords in multiple times, identify the number of the same object keywords with respect to the one image as one.

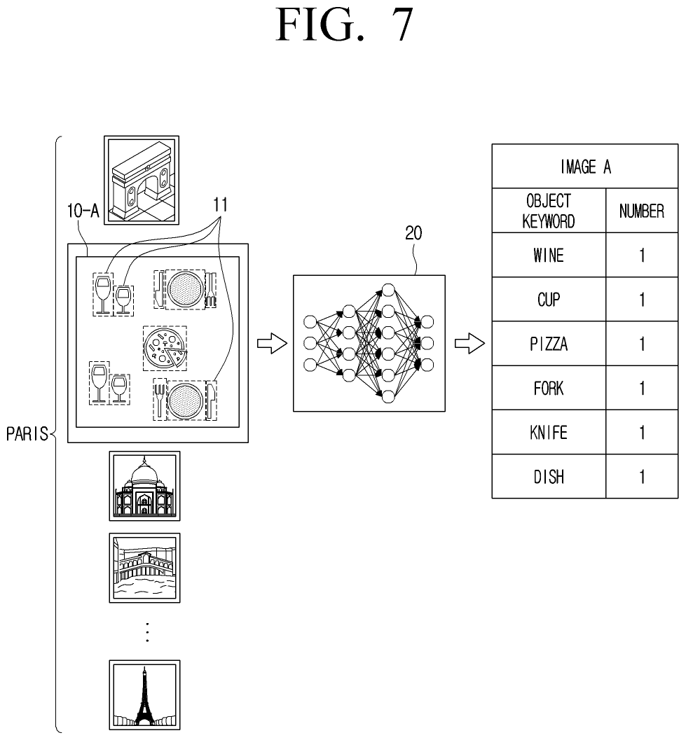

FIG. 7 is for a diagram illustrating an example method of identifying a frequency with respect to each object keyword in the case that the same object keywords among a plurality of object keywords corresponding to one image are included in multiple times according to various embodiments.

For example, as mentioned above, the processor 120 may identify the accumulated number of the object keyword obtained by inputting each image into the first neural network model 20 as a frequency of each object keyword. If the same object keywords are obtained in multiple times in the specific image, the processor 120 may identify the plurality of object keywords obtained through the specific image as one.

For example, if the same objects or the same type of the objects are included in multiple times in one specific image, the object keywords corresponding to the relevant objects may be also obtained in multiple times. As a result, even though the image including the relevant objects is one, the processor 120 may incorrectly determine that the relevant objects are meaningfully related to or have high relevance with the user position because of the object keywords obtained in multiple times. Therefore, the processor 120 may obtain a plurality of object keywords through the first neural network model 20 with respect to a specific image among the plurality of images 10 and if the same object keywords are identified as being included in multiple times among the obtained plurality of object keywords, may change and identify the number of the same plurality of object keywords as one.

For example, with reference to FIG. 7, an image 10-A among the plurality of images 10 corresponding to Paris includes 11 objects 11 (e.g., one wine, four cups, two forks, two knives, two dishes, and one pizza). Therefore, the processor 120, when inputting the image 10-A into the first neural network model 20, may obtain total 11 object keywords (specifically, a keyword about one wine, keywords about four cups, keywords about two forks, keywords about two knives, keywords about two dishes, and a keyword about one pizza) as the object keywords corresponding to the image 10-A. However, the processor 120 may identify the repetitively obtained keywords about the cups as obtaining one from the image 10-A. Likewise, it may also identify the repetitively obtained keywords about the forks, knives, and dishes as obtaining one from the image 10-A, respectively.

As such, the processor 120 may identify a frequency of each object keyword in consideration of the number of the images substantially obtained by the user with respect to each object keyword to select an object keyword having substantially high relevance with the user position.

Hereinafter, an example embodiment of the disclosure in which a background content 220 (e.g., refer to FIG. 8) are generated is described.

According to an embodiment of the disclosure, the processor 120 may generate a background content to be reflected on the virtual space 200 of the metaverse.

The background content 220 may be 3-dimensional background images reflected on the virtual space 200 of the metaverse. For example, the background content 220 may include 3-dimensional images about a building, a road, a bridge, a tree, and the like displayed on the virtual space 200 of the metaverse.

The background content 220 may be realized based on a plurality of object contents. For example, the background content 220 may include the preset object content (e.g. 3-dimensional images such as a person, a building, an animal, food, and an object). The preset object content included in the background content 220 may be separated from an object content 210 generated based on the plurality of images 10 corresponding to the user position. In other words, the object keywords 210 generated based on the object keywords may be separated from the object content used for realizing the background content. For example, a position and a shape of the object content used to realize the background content 220 may be fixed in the virtual space but a position of the object content 210 generated based on the object keywords may be changed in the virtual space according to the input or setting of the user and a shape thereof may be also variously changed.

According to an embodiment of the disclosure, the processor 120, after excluding the object keywords used for realizing the background among the plurality of object keywords obtained from the plurality of images 10 corresponding to the user position, may generate the object content only based on the other object keywords.

Hereinafter, an example method by which the processor 120 generates the background content 220 is described.

The processor 120 may generate the background content 220 based on the user position. For example, the processor 120 may identify the user position and may generate the 3-dimensional background image corresponding to the identified user position. The processor 120 may identify a land mark corresponding to the identified user position and may generate the 3-dimensional images corresponding to the identified land mark as the background content 220. For example, if the processor 120 may identify the user position as Egypt and select the plurality of images 10 corresponding to the identified Egypt, the processor 120 may identify “pyramid” and “sphinx” as the land mark corresponding to Egypt. Further, the processor 120 may generate the 3-dimensional images corresponding to “pyramid” and “sphinx” as a background content 220 corresponding to Egypt. For the above, the processor 120 may use a “city-land mark matching table” stored in the memory 110.

According to an embodiment of the disclosure, “background content 220” may be generated in advance and stored in the memory 110. For example, the memory 110 may store a plurality of background contents 220 corresponding to the preset plurality of user positions. For example, in the case of “Seoul” among the preset plurality of user positions, the 3-dimensional images corresponding to the Namsan Tower and the Gyeongbokgung Palace may be stored in the memory 110 as the background content 220 corresponding to “Seoul”.

The processor 120 may display the object content 210 generated based on the plurality of images 10 corresponding to the user position on the background content 220, thereby realizing the virtual space 200 of the metaverse corresponding to the user position. In other words, when explaining it again, for example, the object content 210 generated through the plurality of images 10 corresponding to Egypt (e.g. 3-dimensional food images) may be displayed on the background content 220 realized by the 3-dimensional images corresponding to the pyramid and the sphinx as aforementioned.

Prior to generating the background content 220, the processor 120 according to an embodiment of the disclosure may identify whether the user position is the preset position.

FIG. 8 is for a diagram illustrating an example method of generating a background content by inputting a plurality images 10 corresponding to a user position into a second neural network model if it is identified that the user position is not the preset position according to various embodiments.

For example, the processor 120 may identify whether the user position corresponding to the selected plurality of images 10 is the preset position. Specifically, with reference to FIG. 8, the preset user position corresponding to each GPS position may be stored in the memory 110. Therefore, the processor 120 may identify whether the user position corresponding to the plurality of images 10 is the preset position based on GPS coordinates obtained through a GPS sensor of the electronic device 100 and metadata included in the plurality of images 10. For example, the processor 120, if it is identified that the GPS position of the user corresponding to the plurality of images 10 is north latitude 51° 30′ 26 and west longitude 0° 7′ 39″ or is within the preset radius in a center of north latitude 51° 30′ 26 and west longitude 0° 7′ 39″, may identify that the user position is London.

Further, according to an embodiment of the disclosure, the processor 120, if it is identified that the user position is not in the preset position, may obtain background keywords corresponding to the user position based on the object keywords of the plurality of images selected to correspond to the user position. Here, the background keywords may be keywords indicating a place predicted as the user position. For example, the processor 120 may obtain the background keywords corresponding to the user position by combining the plurality object keywords obtained through the plurality of images 10 selected to correspond to the user position. For example, if the plurality of object keywords obtained through the plurality of images 10 selected to correspond to the user position are “parasol”, “picnic mat”, “swimsuit”, “goggles”, “seagull”, “seashell”, or the like, the processor may obtain “sea” as the background keyword corresponding to the user position by combining the obtained plurality of object keywords. Also, according to an embodiment of the disclosure, the processor 120 may obtain background keywords corresponding to the plurality of images 10 selected using the neural network model 30 identifying a background within an image.

The neural network model 30 identifying the background in the image may be a neural network model trained to identify a background within an input image and output a keyword about the identified background. For the above, the neural network model identifying the background in the image may be a neural network model pre-trained to identify the background of each image based on learning data including the plurality of images 10. The neural network model 30 identifying the background in the image may be realized, for example, and without limitation, as a convolutional neural network (CNN) model, a fully convolutional networks (FCN) model, a regions with convolutional neuron networks features (RCNN) model, a YOLO model, etc. Hereinafter, for convenience of the description, the neural network model 30 identifying the background in the image according to an embodiment of the disclosure is described and referred to as a second neural network model 30.

As an example, the second neural network model 30 may be a model trained to identify a background in the image based on the object keywords obtained through the first neural network model 20. For example, if the object keyword obtained with respect to the plurality of images 10 through the first neural network model 20 are a swimsuit, a seagull, a seashell, or the like, the second neural network model 30 may identify the user position corresponding to the plurality of images 10 as “sea” based on the obtained object keywords (the swimsuit, the seagull, the seashell, or the like). The disclosure is not limited thereto and the known various technologies may be applied to a method of identifying the background of the plurality of images 10.

With reference to FIG. 8, the processor 120 identifies that the user position corresponding to the plurality of images 10, “177, OO-ro, OO-myeon, OO-gun” or the GPS position corresponding to “177, OO-ro, OO-myeon, OO-gun” is not the preset position (e.g. Paris, London, New York, etc.). Accordingly, the processor 120 may input each of the plurality of images 10 corresponding to the user position into the second neural network model 30 and may obtain the background keywords corresponding to each image. Meanwhile, if the background keyword obtained by the processor 120 through the second neural network model 30 is “campsite”, the processor 120 may generate the 3-dimensional images realizing “campsite” as the background content 220. Further, the processor 120 may display the generated 3-dimensional images of “campsite” on the virtual space 200 of the metaverse.

According to an embodiment of the disclosure, the processor 120 may obtain a plurality of background keywords. For example, the processor 120 may input each image into the second neural network model 30 to obtain the background keywords with respect to each image. Meanwhile, with respect to the image of which a background is not identified, the background keywords may not be obtained through the second neural network model 30. The processor 120 according to an embodiment of the disclosure may determine a background to be reflected on the virtual space 200 of the metaverse based on a frequency of the background keywords corresponding to each of the selected plurality of images 10.

FIG. 9 is for a diagram illustrating an example of generating background content based on a frequency of a plurality of background keywords according to various embodiments.

Hereinafter, for the convenience of the description of the disclosure, the description is made under the assumption of obtaining the background keywords through the second neural network model.

A frequency of the object keywords may be an accumulated number of the background keywords obtained by the processor 120 when the plurality of images 10 selected to correspond to the user position are sequentially input into the second neural network model 30. The frequency of the background keywords may include the accumulated number in which the background keywords are not obtained when the processor 120 inputs a specific image into the second neural network model 30.

For example, the processor 120 may input each of the plurality of images 10 selected to correspond to the user position into the second neural network model 30 and may obtain the background keywords corresponding to each image. Here, the processor 120 may identify the accumulated number of each of the obtained object keywords. Further, the processor 120 may identify the identified accumulated number with respect to each background keyword as a frequency with respect to each background keyword.

Referring to FIG. 9, the processor 120 identifies the accumulated number of “campsite” among the plurality of background keywords as 8. Accordingly, the processor 120 may identify the frequency of “campsite” as 8. Further, the processor 120 identifies the accumulated number of “lawn” as 3. Accordingly, the processor 120 may identify the frequency of “lawn” as 3. Also, the processor 120 identifies the number of not obtaining the background keyword as 5. The fact of not obtaining the background keyword may be not to output the background keyword corresponding to the image when inputting the image into the second neural network model 30. In other words, it may correspond to “Unknown” in FIG. 9.

As such, the processor 120 may identify the accumulated number of each obtained keyword and the accumulated number of not obtaining the background keyword to identify the frequency of each background keyword.

Further, the processor 120 may determine the background keyword having the largest frequency as a background to be reflected on the virtual space 200 of the metaverse. In other words, with reference to FIG. 9, the processor 120 may determine “campsite” having the largest frequency as a background to be reflected on the virtual space 200 of the metaverse. Further, the processor 120 may generate 3-dimensional images corresponding to the determined “campsite”. Specifically, the processor 120 may render 3-dimensional images of “campsite”.

According to an embodiment of the disclosure, the memory 110 may store 3-dimensional images corresponding to the background keyword. Also, the memory 110 may store a plurality of 3-dimensional object images required for realizing a background corresponding to the background keyword.

Otherwise, according to an embodiment of the disclosure, the processor 120 may transmit a background keyword to the external device (e.g. an external server) through the communication part of the electronic device and may obtain the 3-dimensional background image corresponding to the background keyword from the external device through the communication part.

According to an embodiment of the disclosure, the processor 120 may identify the obtained background keywords as the user position. Through the above, the processor 120 may identify semantic similarity which is a criterion of selecting the second keyword with respect to the background keywords and a plurality of first keywords. For example, with reference to FIG. 9, the processor 120 may input the plurality of images 10 selected to correspond to “177, OO-ro, OO-myeon, OO-gun” corresponding to the user position into the first neural network model 20 to obtain a plurality of object keywords. Further, the processor 120 may select first object keywords among a plurality of object keywords based on a frequency of the obtained object keywords. The processor 120 may identify semantic similarity between “campsite”, which is the background keyword obtained based on the second neural network model 30 and the plurality of first object keywords. Further, the processor 120 may select at least one object keyword of which semantic similarity is equal to or greater than the preset value as second object keywords. In other words, the processor 120 may utilize the background keyword rather than the user position (“177, OO-ro, OO-myeon, OO-gun”) identified based on the GPS coordinates to identify semantic similarity.

According to an embodiment of the disclosure, the processor 120 may identify a plurality of texts 50 obtained for a period corresponding to the user position, obtain a plurality of emotion keywords corresponding to the plurality of texts 50 using the neural network model identifying emotions corresponding to the texts 50, and determine a background reflected on the virtual space 200 of the metaverse based on the obtained emotion keywords and the user position.

FIG. 10 is a diagram illustrating an example of obtaining a plurality of emotion keywords corresponding to a plurality of texts obtained for a period corresponding to a user position based on a third neural network model according to various embodiments.

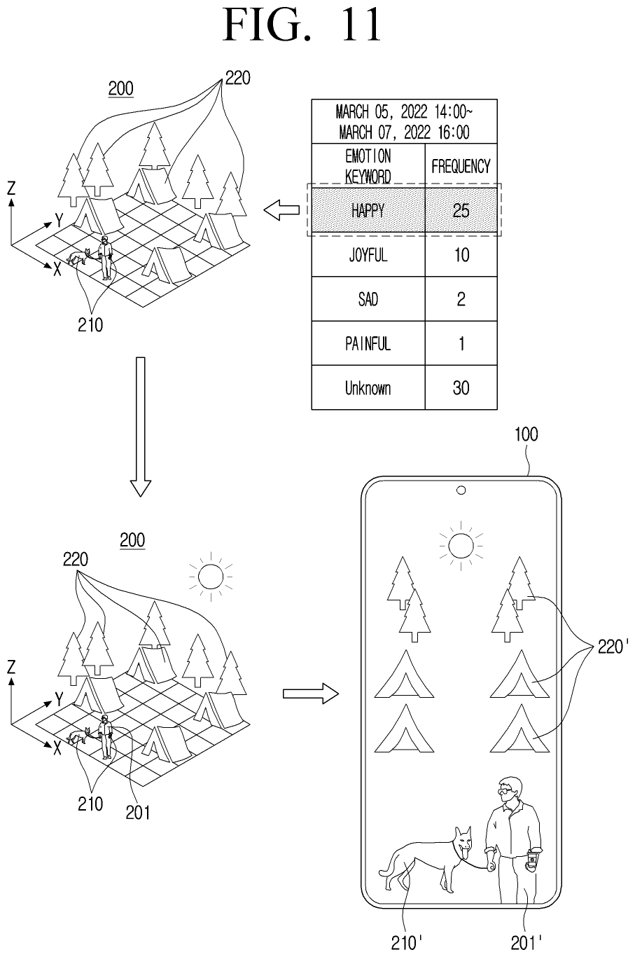

FIG. 11 is for a diagram illustrating an example of generating a background content based on a frequency of a plurality of emotion keywords according to various embodiments.

For example, the processor 120 may identify the plurality of texts 50 obtained for the period corresponding to the user position. For example, the processor 120 may identify the period corresponding to each user position. The processor 120 may identify a period corresponding to the user position based on the GPS position of the electronic device 100 or the metadata of each image. With respect to the above, the description is made with reference to FIG. 3 as aforementioned and thus the detailed description is omitted.

The processor 120 may identify the texts 50 which is obtained through a messenger or a SNS for the period corresponding to the user position or is stored in the memory 110, or the texts 50 input through the input interface. For example, with reference to FIG. 10, the processor 120 may identify at least one text 50 obtained for the period (from Mar. 5, 2022 14:00 to Mar. 7, 2022 16:00) corresponding to the user position “177, OO-ro, OO-myeon, OO-gun”.

Further, the processor 120 may obtain at least one emotion keyword corresponding to the identified plurality of texts 50. For example, the processor 120 may analyze the identified plurality of texts 50 and infer the meaning of each text to obtain emotion keywords corresponding to each text.

The processor 120 according to an embodiment of the disclosure may obtain at least one emotion keyword corresponding to the text using the neural network model. For example, the neural network model identifying emotions corresponding to the texts may be a neural network model trained to infer the meaning of each text and identify emotions corresponding to each text 50. Hereinafter, for the convenience of the description, the description is made in a way that the neural network model identifying emotions corresponding to the texts according to an embodiment of the disclosure is referred to as a third neural network model 40.

According to an embodiment of the disclosure, the third neural network model 40 may be a model pre-trained to analyze emotions with respect to each text 50 based on learning data including the plurality of texts and output emotion keywords corresponding to each text 50. For example, if each of the plurality of texts 50 is input into the third neural network model 40, the third neural network model 40 may be trained to obtain information about intention of the user included in each text 50 and output emotion keywords corresponding to information about the obtained intention. The third neural network model 40 may be implemented as, for example, and without limitation, a BERT model, a natural language understanding (NLU) model, etc.

According to an embodiment of the disclosure, the processor 120 may determine a background to be reflected on the virtual space 200 of the metaverse based on the obtained emotion keywords corresponding to the plurality of texts 50.

For example, the processor 120 may identify the user position and generate 3-dimensional background images corresponding to the identified user position. For example, the processor 120 may identify whether the user position is the preset position and if it is identified that the user position is the preset position, may obtain the background content 220 corresponding to the preset position from the memory 110. In other words, the 3-dimensional background images corresponding to the preset position may be obtained from the memory 110. The processor 120 may obtain the background keyword corresponding to the user position if it is identified that the user position is not the preset position and may obtain the background content 220 corresponding to the obtained background keyword from the memory 110. The method of generating the background content 220 based on the background keyword is described in FIGS. 8 and 9 as aforementioned and thus the detailed description thereof may not be repeated here.

The processor 120, after generating the background content 220 based on the user position or the background keywords, may change color of the generated 3-dimensional background images based on the emotion keywords obtained through the third neural network model 40 or may add an object to the 3-dimensional background images.

For example, a color, weather, time, and the like of the background content 220 may be determined based on the emotion keywords. For example, despite the 3-dimensional background images generated to correspond to the same user position, the processor 120 may change a color of the 3-dimensional background images to a bright color if the emotion keyword obtained through the third neural network model 40 is “happy”. The processor 120 may change a color of the 3-dimensional background images to a dark color if the emotion keyword obtained through the third neural network model 40 is “sad”.

In realizing the 3-dimensional background images, the processor 120 may change weather in the background images to “sunny” if the emotion keyword obtained through the third neural network model 40 is “happy”. The processor 120 may change weather in the background image to “rain” if the emotion keyword obtained through the third neural network model 40 is “sad”. For the above, the processor 120 may generate and display the object content 210, e.g. the 3-dimensional object images on the background images to realize weather.

In realizing the 3-dimensional background images, the processor 120 may change time in the background images to “morning” if the emotion keyword obtained through the third neural network model 40 is “happy”. The processor 120 may change time in the background images to “night” if the emotion keyword obtained through the third neural network model 40 is “sad”.

According to an embodiment of the disclosure, the emotion keyword used for determining a background to be reflected on the virtual space 200 of the metaverse may be identified based on the frequency of the emotion keyword obtained to correspond to each of the plurality of texts 50.

Hereinafter, for the convenience of the description of the disclosure, the description is made under the assumption of obtaining the emotion keywords through the third neural network model.

A frequency of the emotion keywords may be an accumulated number of the emotion keywords obtained by the processor 120 when sequentially inputting the plurality of texts 50 obtained for a period corresponding to the user position (or stored in the memory 110) into the third neural network model 40. The frequency of the emotion keywords may include the accumulated number in which the background keywords are not obtained when the processor 120 inputs a specific text 50 into the third neural network model 40.

For example, the processor 120 may input each of the plurality of texts 50 obtained for a period corresponding to the user position (or stored in the memory 110) into the third neural network model 40 and may obtain the emotion keyword corresponding to each text 50. Further, the processor 120 may identify the accumulated number of each of the obtained emotion keywords. Further, the processor 120 may identify the identified accumulated number with respect to each emotion keyword based on a frequency with respect to each emotion keyword.

According to FIG. 10, the processor 120 identifies the accumulated number of “happy” among the obtained plurality of emotion keywords as 25. In other words, the frequency of “happy” is identified as 25. Further, the processor 120 identifies the accumulated number of “joyful” as 10. In other words, the frequency of “joyful” is identified as 10. Also, the processor 120 identifies the number of not obtaining the emotion keyword as 30. The fact of not obtaining the emotion keyword may be not to output the emotion keyword corresponding to the text 50 when inputting the text 50 into the third neural network model 40. In other words, it may correspond to “Unknown” in FIG. 10.

As such, the processor 120 may identify the accumulated number of each obtained keyword whenever each emotion keyword is obtained or the accumulated number of not obtaining the emotion keyword whenever the emotion keyword is not obtained, thereby identifying the frequency of each background keyword.

Further, the processor 120 may select the emotion keyword having the largest frequency among the plurality of emotion keywords and may generate a background content 220 based on the selected emotion keyword. For example, with reference to FIG. 11, the processor 120 may generate the background content 220 based on “happy” which is the emotion keyword having the highest frequency among the plurality of emotion keywords. When describing it again, for example, the processor 120 may determine weather of the background content 220 based on the emotion keyword as aforementioned. If weather corresponding to the emotion keyword “happy” is set to “sunny”, the processor 120 may set weather of the background reflected on the virtual space 200 of the metaverse to “sunny”. In the case that the frequency of “Unknown” is the highest among the plurality of emotion keywords, the processor 120 may generate the background content 220 only based on the user position or the background keyword.

With reference to FIG. 11, the processor 120 may obtain “campsite” as the background keyword with respect to the plurality of images 10 corresponding to the user position through the second neural network model 30. Further, the processor 120 may render the 3-dimensional campsite images based on the obtained background keyword (“campsite”). Further, the 3-dimensional images corresponding to “campsite” stored in the memory 110 are obtained. Further, the processor 120 may obtain the object keyword with respect to the plurality of images 10 corresponding to the user position through the first neural network model 20.

According to FIG. 11, the processor 120 obtains the object keywords “coffee” and “puppy”. Accordingly, the processor 120 may generate 3-dimensional object images (3-dimensional coffee images and 3-dimensional puppy images) as the object content 210 corresponding to each object keyword. Further, the processor 120 may display the generated 3-dimensional object images on the 3-dimensional campsite images. In other words, the generated 3-dimensional object image may be incorporated into the 3-dimensional background image. Further, the processor 120 may obtain the emotion keyword with respect to the plurality of texts 50 obtained for the period corresponding to the user position (stored in the memory 110) through the third neural network model 40. If the obtained emotion keyword is “happy” and weather of the background content 220 corresponding to “happy” is set to “sunny”, the processor 120 may display the 3-dimensional sun images in the 3-dimensional background images and may display the background content 220 of sunny weather by adjusting a color of the 3-dimensional background images. As such, the processor 120 may generate a content reflected on the virtual space of the metaverse based on “object keyword”, “background keyword”, and “emotion keyword”.

An embodiment of the disclosure as aforementioned describes that the emotion keyword used for determining a background to be reflected on the virtual space 200 of the metaverse is obtained based on the plurality of texts 50 obtained for the period corresponding to the user position but the disclosure is not limited thereto. According to an embodiment, the emotion keyword may be obtained based on the plurality of texts 50 and a plurality of audios (e.g. a recorded telephone conversation and voice information in a recorded video) obtained for the period corresponding to the user position. The processor 120 may obtain the plurality of texts 50 corresponding to the plurality of audios. In other words, the processor 120 may perform voice recognition about each audio and may obtain texts 50 corresponding to each audio. Further, the processor 120 may input the obtained texts 50 into the third neural network model 40 to obtain the emotion keyword.

According to an embodiment of the disclosure, the electronic device 100 may further include a display and a communication interface. Here, according to an embodiment of the disclosure, the processor 120 may transmit an object content 210 to an external server, receive a virtual space image including the object content 210, and control the display to display the received virtual space image.

According to an embodiment of the disclosure, the processor 120 may transmit the generated object content 210 to the external server. Specifically, the processor 120 may transmit the 3-dimensional object images generated based on the object keywords to the external server through the communication interface. Here, 3-dimensional background images generated based on the user position or the background keyword may be also transmitted to the communication server through the communication interface.

Further, the external server may display the object content 210 and the background content received from the electronic device 100 at a position corresponding to the user position in the 3-dimensional virtual space 200 of the metaverse. Specifically, the external server may divide the virtual space 200 into a plurality of areas according to the user position. Further, the external server may display an object content and a background content corresponding to the user position received from an area corresponding to each user position.

The external server may be a device which receives the object content 210 and the background content obtained from each of the plurality of electronic device 100 including the electronic device 100 and realizes a virtual environment of the metaverse corresponding to each electronic device 100 based the received object content 210 and the background content.

The external server may distinguish and generate the 3-dimensional virtual space 200 of the metaverse corresponding to each of the plurality of electronic device 100 in communication with the external server. Further, the object content 210 received from each electronic device 100 in the 3-dimensional virtual space 200 of the metaverse corresponding to each electronic device 100 may be displayed. The external server may be implemented as a cloud server, etc.

For example, the external server receiving the object content 210 from the electronic device 100 may generate the virtual space 200 of the metaverse based on the received object content 210. The virtual space 200 of the metaverse may be a 3-dimensional virtual space to which a plurality of users may be connected or into which the users may enter through each electronic device 100. The external server may display the object content 210 at a position and a space corresponding to the electronic device 100.

In other words, the external server may display 3-dimensional images corresponding to the object content 210 received from a position and a space assigned to the electronic device 100 in the 3-dimensional virtual space of the metaverse. If the external server receives the background content 220, the received background content 220 may be displayed at a position and a space assigned to the electronic device 100 in the 3-dimensional virtual space of the metaverse. In other words, the external server may display 3-dimensional background images at the position and the space assigned to the electronic device 100 in the 3-dimensional virtual space and may display the 3-dimensional object image in the displayed 3-dimensional background image.

The processor 120 may receive the virtual space image including the object content 210 from the external server through the communication interface. Further, the processor 120 may control the display to display the received virtual space image.

For example, with reference to FIG. 11, the processor 120 may receive, from the external server, the virtual space image realized by the 3-dimensional camping images generated based on the emotion keyword and the background keyword, and the 3-dimensional object images (e.g. a 3-dimensional coffee image and a 3-dimensional puppy image) generated based on the object keywords. Further, the processor 120 may display the received virtual space image on the display. Here, the virtual space images received by the processor 120 may be images about the background content 220 and the object content 210 obtained at a specific time point in the 3-dimensional space of the metaverse.

For example, the virtual space image received by the processor 120 may include a 2-dimensional object content 210′ corresponding to a 3-dimensional object content 210 reflected on the virtual space, a 2-dimensional background content 220′ corresponding to a 3-dimensional background content 220 reflected on the virtual space, and the 2-dimensional user content 201′ corresponding to the 3-dimensional user content 220 reflected on the virtual space. Here, the 2-dimensional object content 210′ may be 2-dimensional images capable of being obtained at a specific viewpoint with respect to the 3-dimensional object content 210 reflected on the virtual space. Likewise, the 2-dimensional background content 220′ and the 2-dimensional user content 201′ may be images to be obtained when the 3-dimensional content reflected on each virtual space are viewed at the specific viewpoint.

With reference to FIG. 11, the electronic device 100, after receiving 2-dimensional images 201′, 210′, and 220′ obtained in a y-axial direction with respect to the user content 201, the object content 210, and the background content 220 reflected on the 3-dimensional virtual space, may display the received 2-dimensional images 201′, 210′, and 220′ on the display.

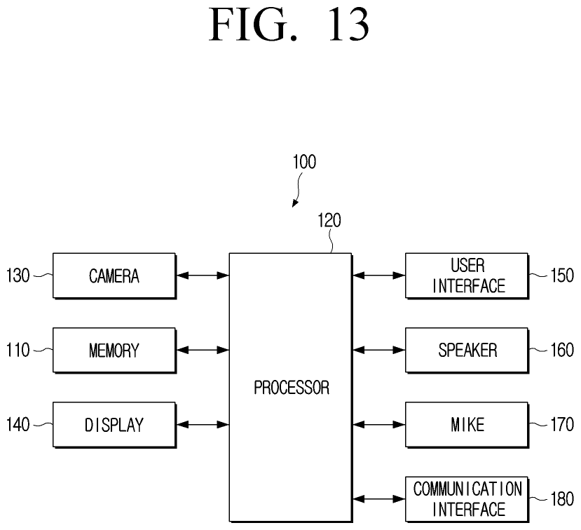

The display and the communication interface included in the electronic device 100 according to an embodiment of the disclosure are described in greater detail below with reference to FIG. 13.

According to an embodiment of the disclosure, the 3-dimensional virtual space of the metaverse may be realized based on the object content and the background content generated by the electronic device 100. In other words, the electronic device 100 may generate the virtual space 200 corresponding to each user position based on the object content (3-dimensional object images) and the background content (3-dimensional background images) corresponding to each user position.

According to an embodiment of the disclosure, the processor 120 may control the display to display a UI for displaying at least one image corresponding to the object content 210 at a position corresponding to the object content 210 in the virtual space images.

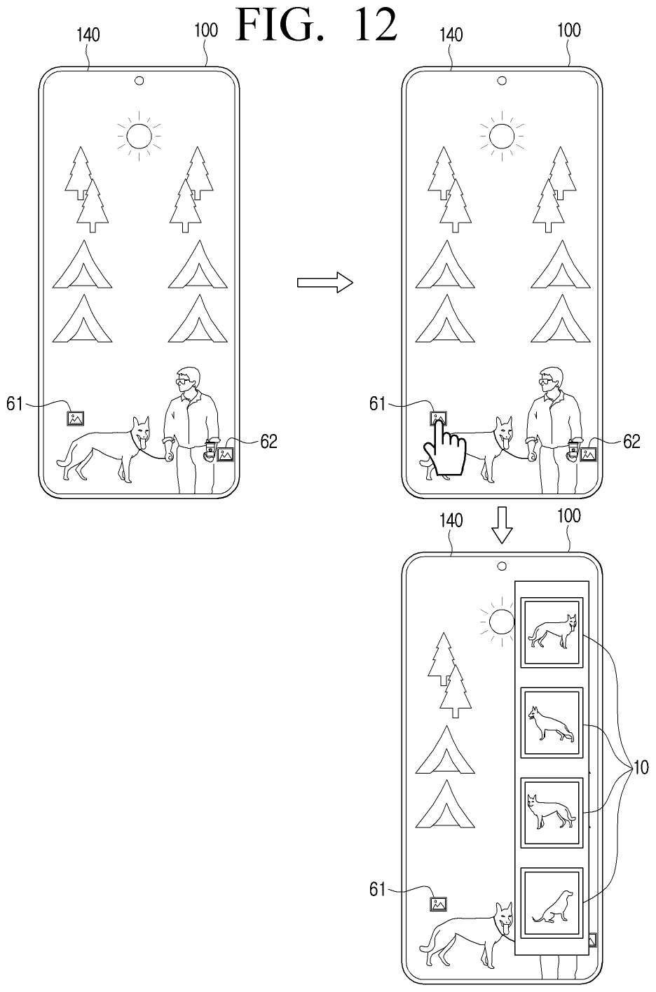

FIG. 12 is for a diagram illustrating an example UI for displaying at least one image corresponding to an object content according to various embodiments.

For example, the processor 120 may control the display to display the UI for displaying at least one image on the object image in the virtual space image received from the external server.

The at least one image displayed through the UI may include an image obtaining the object keywords corresponding to the object images. For example, with reference to FIG. 12, the processor 120 may display the UIs 61, 62 on a “coffee” image and a “puppy” image corresponding to the object content 210 displayed on the display. If it is identified that the UIs 61, 62 displayed on the “puppy” image is selected through a touch input of the user or if the touch input of the user is sensed through the UIs 61, 62, the processor 120 may display at least one image used for generating the “puppy” image on the display.

For example, the processor 120 may display at least one image obtaining “puppy” as the object keyword when inputting it into the first neural network model 20. Through the above, the user may receive the images 10 related to each object in the virtual space 200 of the metaverse.

FIG. 13 is a block diagram illustrating an example configuration of an electronic device according to various embodiments.

According to FIG. 13, the electronic device 100 according to an embodiment of the disclosure includes memory 110, a camera 130, a display 140, a user interface (e.g., including circuitry) 150, a speaker 160, a mike (e.g., microphone) 170, a communication interface (e.g., including communication circuitry) 180, and a processor (e.g., including processing circuitry) 120. The detailed description of components overlapping with the components shown in FIG. 2 among components shown in FIG. 13 may not be repeated here.

The camera 130 may obtain images. For example, the camera may obtain an image including an object by capturing the object (e.g. a subject) present in the field of view (FoV) at a specific point of view (PoV). The processor 120 may classify the plurality of images 10 which are obtained through the camera and are stored in the memory 110 according to the user position and may generate the object content 210 based on the plurality images 10 corresponding to the user position.

The display 140 may display various information. When explaining it again, for example, the processor 120 may display the object content 210 and the background content 220 through the display. Specifically, the processor 120 may display the generated 3-dimensional object images and 3-dimensional background images. Here, the processor 120 may display the 3-dimensional object images on the 3-dimensional background images. For the above, the display 140 may be implemented as, for example, and without limitation, various types of displays such as LCD, LED, OLED, or the like.

A user interface 160 may include various circuitry by which the electronic device 100 performs interactions with the user. For example, the user interface 150 may include at least one of a touch sensor, a motion sensor, a button, a jog dial, a switch, a mike, or a speaker but is not limited thereto. For example, the processor 120 may move the object content 210 displayed on the 3-dimensional virtual space 200 of the metaverse according to the user input through the user interface 160 or may control movement thereof.

The mike (e.g., microphone) 160 may refer, for example, to a module obtaining and converting a voice to an electric signal and may be a condenser mike, a ribbon mike, a moving coil mike, a piezoelectric element mike, or a micro electro mechanical system (MEMS) mike. Also, it may be implemented in an omnidirectional method, a bidirectional method, a unidirectional method, a sub cardioid method, a super cardioid method, or a hyper cardioid method.

The processor 120 may include various processing circuitry and obtain emotion keywords based on a voice obtained through the mike 160. For example, it may convert the voice obtained through the mike 160 to the texts 50 corresponding to the voice and may input the converted texts 50 into the third neural network model 40 to obtain emotion keywords corresponding to the voice. Here, based on the obtained emotion keywords, the processor 120 may generate the background content 220. The detailed description of the processor 120 above is equally applicable here.

A speaker 170 may include a tweeter for playing sound in a high range of sound, a mid range for playing sound in a mid range of sound, a woofer for playing sound in a low range of sound, a sub woofer for playing sound in the lowest range of sound, an enclosure for controlling resonance, a crossover network for dividing an electric signal frequency input into the speaker according to its range.

The speaker 170 may output a sound signal to the outside of the electronic device 100. The speaker 170 may play a multi-media content, a record and may various alarm sounds, voice messages, etc. The electronic device 100 may include an audio output device such as the speaker 170 but may include an output device such as an audio output terminal. In particular, the speaker 170 may provide obtained information, information processed and produced based on the obtained information, a response result or an operation result about the user voice, or the like in a voice from.

The communication interface 180 may include various communication circuitry and perform communication with various external devices (e.g. an external server) to transmit/receive various information. In particular, the processor 120 may transmit the generated object content 210 and the background content 220 to the external server through the communication interface. The object content 210 and the external server receiving a virtual content may generate images of the virtual space 200 of the metaverse based on the received object content 210 and the virtual content. Further, the processor 120 may receive the images of the virtual space 200 of the metaverse generated from the external server through the communication interface.

For the above, the communication interface may include at least one communication module of a short range wireless communication module (not shown) and a wireless LAN communication module (not shown). The short range wireless communication module (not shown) is a module wirelessly performing data communication with external equipment located at a short range and may be, for example, a Bluetooth module, a ZigBee module, a near field communication (NFC) module, an infrared communication module, etc. Also, the wireless LAN communication module (not shown) is a module connected to an external network according to a wireless communication protocol such as Wi-Fi and IEEE and performing communication with the external server or the external equipment.

The aforementioned methods according to various examples of the disclosure may be implemented as an application installable in the existing electronic device 100. The methods according to various examples of the disclosure as aforementioned may be performed using a deep learning-based artificial neural network (or a deep artificial neural network), e.g. a learning network model. Also the aforementioned methods according to various examples of the disclosure may be implemented only with a software upgrade or a hardware upgrade with respect to the existing electronic device 100. It is possible to perform the aforementioned various examples of the disclosure through an embedded server included in the electronic device 100 or the external server of the electronic device 100.

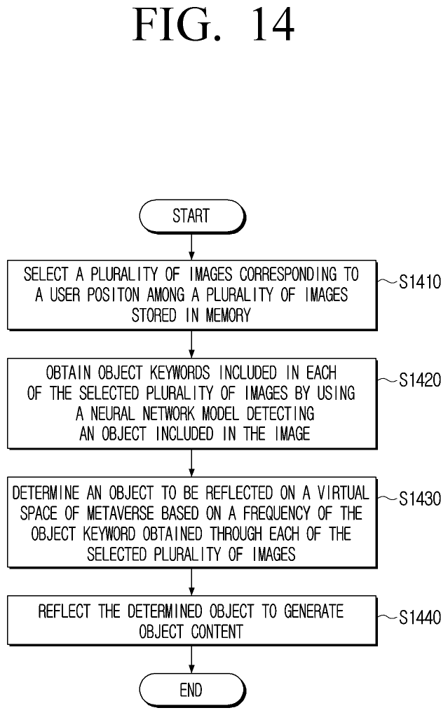

FIG. 14 is a flowchart illustrating an example method of operating an electronic device according to various embodiments.

With reference to FIG. 14, in advance, the processor 120 may select a plurality of images 10 corresponding to the user position among the plurality of images 10 (S1410).

For example, the processor 120 may classify the plurality of images 10 stored in the memory 110 according to each user position. Here, the plurality of images 10 corresponding to the user position may be images obtained and stored in the memory 110 while the user stays in a specific position. Specifically, the images may be images stored in the memory 110 after obtained by the user through a camera at a specific position or may be images stored in the memory 110 after received from another electronic device 100 through the communication interface while the user is in the specific position.

The processor 120, if changing of the user position is sensed, may select the plurality of images 10 corresponding to the user position before the changing among the plurality of images 10 stored in the memory 110. Here, the processor 120 may generate a content (e.g. an object content) to be reflected on the virtual space 200 of the metaverse based on the selected plurality of images 10.

Further, the processor 120 may obtain object keywords included in each of the selected plurality of images 10 using the neural network model 20 (e.g. a first neural network model 20) detecting an object included in the image after selecting the plurality of images 10 corresponding to the user position (S1420). The object keyword may be a keyword indicating a type, a kind, and the like of the detected object.

Still further, the processor 120 may determine an object to be reflected on the virtual space 200 of the metaverse based on a frequency of the object keyword obtained through each of the selected plurality of images 10 (S1430). A frequency of the object keywords may be an accumulated number of the object keywords obtained by the processor 120 when the plurality of images 10 selected to correspond to the user position are sequentially input into the first neural network model 20.

According to an embodiment of the disclosure, the processor 120 may select a frequency each of the object keywords, select the plurality of first object keywords of which the identified frequency is equal to or greater than among the plurality of object keywords, and determine an object to be reflected on the virtual space 200 of the metaverse based on the selected plurality of first object keywords.

According to an embodiment of the disclosure, the processor 120 may also identify semantic similarity between the user position and the plurality of first object keywords, select the second object keywords having semantic similarity in which the identified semantic similarity is equal to or greater than among the plurality of first object keywords, and determine an object to be reflected on the virtual space 200 of the metaverse based on the selected second object keywords. In other words, the processor 120 may select the first object keywords having high relevance with the user position among the plurality of object keywords as the second object keywords and may determine an object corresponding to the selected object keywords as an object to be reflected on the virtual space 200 of the metaverse.

According to an embodiment of the disclosure, the processor 120, after determining the object to be reflected on the virtual space 200 of the metaverse, may generate the object content 210 corresponding to the determined object. The object content 210 may be 3-dimensional images of the determined object. Therefore, the processor 120 may render 3-dimensional images of the determined object. Meanwhile, the disclosure is not limited thereto and the memory 110 may store 3-dimensional images corresponding to each object keyword. Accordingly, the processor 120 may obtain 3-dimensional images corresponding to the object keyword related to the determined object and may generate the object content 210.

According to an embodiment of the disclosure, the processor 120 may generate the object content 220 to be reflected on the virtual space 200 of the metaverse.

For the above, according to an embodiment of the disclosure, the processor 120, after selecting the plurality of images 10 corresponding to the user position, may identify that the user position is the preset position. Here, the processor 120, if it is identified that the user position is not in the preset position, may obtain background keywords of each of the selected plurality of images 10 using the neural network model (e.g. the second neural network model 30) identifying a background of the image.

Still further, the processor 120 may determine a background to be reflected on the virtual space 200 of the metaverse based on a frequency of the background keyword corresponding to each of the selected plurality of images 10. For example, the processor 120 may determine a background to be reflected on the virtual space 200 of the metaverse as the background keyword having the largest frequency.

The processor 120 may generate the background content 220 corresponding to the determined background. In other words, the processor 120 may render 3-dimensional background images corresponding to the determined background. In addition, in common with the object content, the memory 110 may store 3-dimensional background images corresponding to each background keyword. Here, the processor 120 may obtain 3-dimensional background images corresponding to the background keyword from the memory 110.

The processor 120, if it is identified that the user position is not in the preset position, may identify semantic similarity between the background keyword and the plurality of first object keywords.

According to an embodiment of the disclosure, the processor 120 may identify at least one text 50 obtained for a period corresponding to the user position, obtain emotion keywords corresponding to the at least one text 50 using the neural network model identifying emotions corresponding to the text 50, and determine a background reflected on the virtual space 200 of the metaverse based on the obtained emotion keywords and the user position. For example, the processor 120 may set a color, weather, time, or the like of the background content 220 based on the obtained emotion keyword.

In the detailed description, the operations S1410 to S1440 may be segmented into additional operations or may be integrated into fewer operations according to an embodiment of the disclosure. Also, some operations may be omitted and sequences among operations may be changed as required.

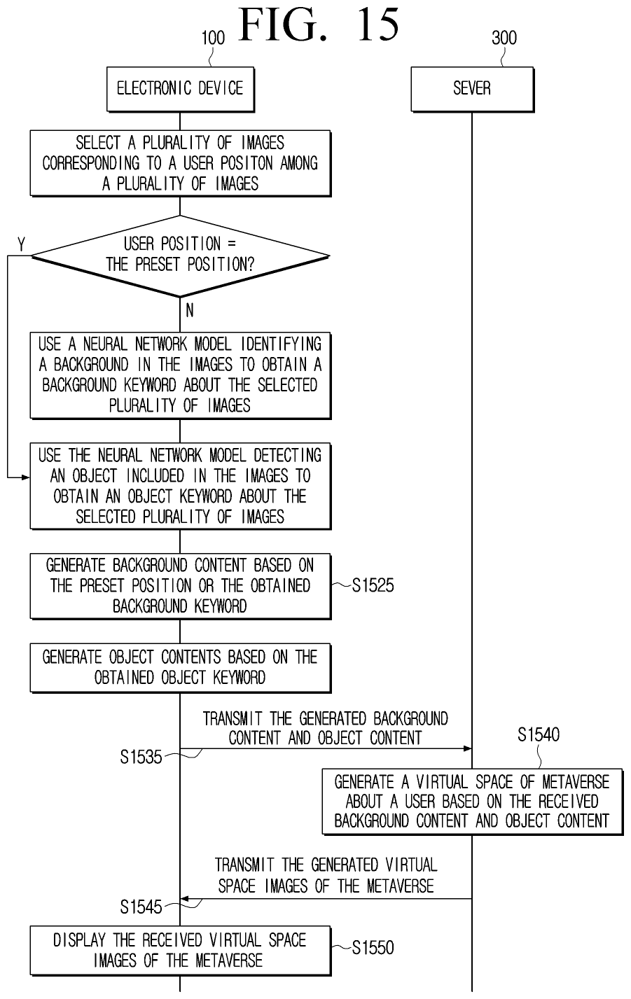

FIG. 15 is a signal flow diagram illustrating an example method in which an electronic device operates as a user terminal device according to an embodiment. The detailed description of operations overlapping with those of FIG. 14 may not be repeated here.

According to an embodiment of the disclosure, the electronic device 100 may be a user terminal device. The user terminal device may include at least one of a TV, a smartphone, a tablet PC, a desk-top PC, or a notebook PC.

The processor 120 of the electronic device 100 may generate the background content 220 based on the preset position and the background keywords. For example, 3-dimensional background images corresponding to each preset position may be generated in advance and stored in the memory 110. Also, 3-dimensional background images corresponding to each background keyword may be generated in advance and stored in the memory 110. Meanwhile, the generated 3-dimensional background images in advance corresponding to the each preset position or the generated 3-dimensional background images in advance corresponding to the each background keyword may be obtained from the external server and may be stored in the memory 110. However, the disclosure is not limited thereto.

The processor 120, if it is identified that the user position is the preset position, may obtain 3-dimensional background images corresponding to the preset position from the memory 110. Also, the processor 120, if it is identified that the user position is not the preset position, may obtain the 3-dimensional background images corresponding to the background keyword obtained with respect to the plurality of images 10 from the memory 110.

Therefore, the processor 120 may generate 3-dimensional object images based on the object keywords. In common with 3-dimensional background images, the 3-dimensional object images may be also generated in advance to correspond to each object keyword and may be stored in the memory 110. With respect to the above, the aforementioned description of the background content 220 may be identically applied thereto and thus the detailed description thereof is omitted.

The processor 120 may transmit the generated background content 220 and the object content 210 to the external server 300 (S1535). Further, the external sever 300 may reflect the received background content 220 and the object content 210 on the virtual space of the metaverse to realize the user-customized virtual space (S1540). Still further, the external server 300 may transmit the generated virtual space images of the metaverse to the electronic device 100 (S1545).

Still further, the processor 120 of the electronic device 100 may display the received virtual space images of the metaverse on the display (S1550).

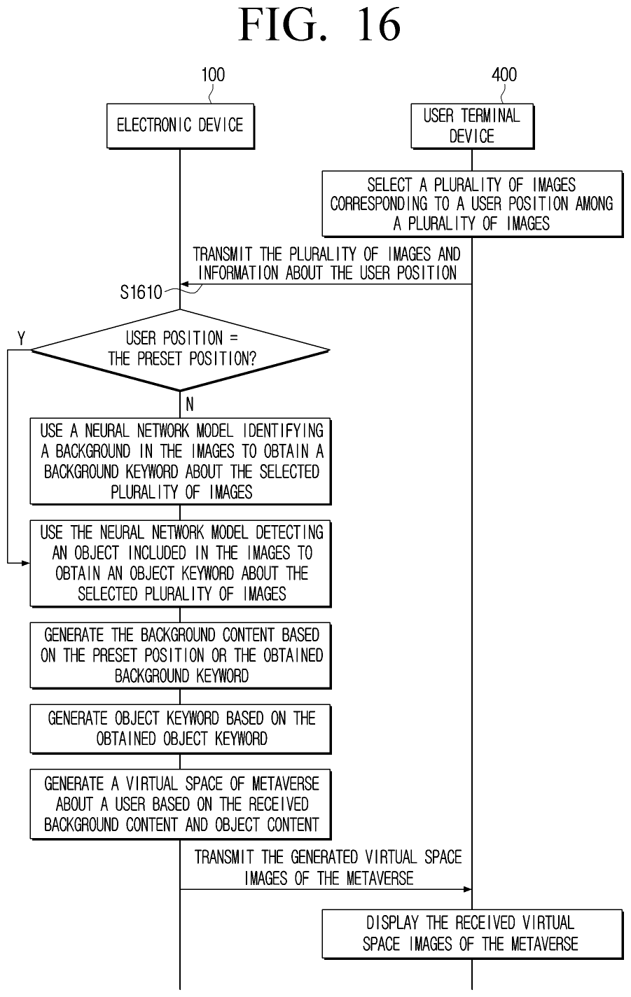

FIG. 16 is a signal flow diagram illustrating an example method in which an electronic device operates as a server according to various embodiments. The detailed description of operations overlapped with those of FIGS. 14 and 15 may not be repeated here.

According to an embodiment of the disclosure, the electronic device 100 may be a server. Here, the server may include a cloud server, etc.

The electronic device 100 may receive a plurality of images 10 and information about the user position from a user terminal device 400 (S1610). Specifically, the user terminal device 400 may transmit the information about the user position (e.g. the GPS coordinates, etc.) together with the plurality of images 10 corresponding to the user position to the electronic device 100.

Further, the electronic device 100 may generate the object content 210 and the background content 220 to be reflected on the virtual space of the metaverse based on the received plurality of images 10 and information about the user position. Further, the electronic device 100 may reflect the generated object content 210 and the background content 220 on the virtual space 200 of the metaverse to realize the user (the user of the user terminal device 400)-customized virtual space 200 of the metaverse.

According to an embodiment of the disclosure, various examples described above may be implemented as software including instructions stored in machine-readable storage media, which can be read by a machine (e.g.: a computer). The machine refer to a apparatus which calls instructions stored in storage media and is operable according to the called instructions, wherein it may include the electronic device (e.g. a display device A) according to the disclosed embodiments. If the instructions are executed by a processor, the processor may perform a function corresponding to the instructions directly or using the other components under control of the processor. The instructions may include a code generated or executed by a compiler or an interpreter. The machine-readable storage media may be provided as non-transitory storage media. Here, the ‘non-transitory’ storage media do not include a signal and are tangible, wherein it does not distinguish whether data is stored in the storage media semipermanently or temporarily.

Also, according to an embodiment, a method according to various examples described above may be provided to be included in a computer program product. The computer program product may be traded between a seller and a buyer as a product. The computer program product may be distributed on-line in a form of the machine-readable storage media (e.g. compact disc read only memory (CD-ROM)) or via an application store (e.g. Play Store™). In the case of on-line distribution, at least part of the computer program product may be stored at least temporarily in the storage media such as memory of a server of a manufacturer, a server of an application store, or a relay server or may be generated temporarily.

Also, each of components (e.g. a module or a program) according to the various embodiments above may be configured as a single item or plural items, wherein partial sub components of the aforementioned relevant sub components may be omitted or another sub component may be further included in various embodiments. Mostly or additionally, some components (e.g. a module or a program) may be integrated into one item and may identically or similarly perform a function implemented by each of the relevant components before integration. According to various embodiments, operations performed by a module, a program, or another component may be executed sequentially, in parallel, repetitively, or heuristically, or at least part of the operations may be executed in different orders or be omitted, or another operation may be added.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. An electronic device, comprising:
memory storing a plurality of images; and
at least one processor, comprising processing circuitry, individually and/or collectively, configured to generate a content to be displayed in a virtual space of metaverse using the plurality of images,
wherein at least one processor, individually and/or collectively, is configured to:
select a plurality of images corresponding to a user position among the plurality of images, obtain an object keyword included in each of the selected plurality of images, determine an object to be reflected on the virtual space of the metaverse based on a frequency of the object keyword obtained through each of the selected plurality of images, and generate an object content corresponding to the determined object.

2. The electronic device of claim 1, wherein at least one processor, individually and/or collectively, is configured to:
identify a frequency of each of obtained object keywords, select a plurality of first object keywords in which the identified frequency are equal to or greater than a specified value among the plurality of object keywords, and determine an object to be reflected on the virtual space of the metaverse based on the selected plurality of first object keywords.

3. The electronic device of claim 2, wherein at least one processor is configured to:
identify semantic similarity between the user position and the plurality of first object keywords,
select second object keywords having semantic similarity in which the identified semantic similarity is equal to or greater than a specified value among the plurality of first object keywords, and based on the selected second object keywords, determine an object to be reflected on the virtual space of the metaverse.

4. The electronic device of claim 1, wherein at least one processor, individually and/or collectively, is configured to:
identify a number of object keywords corresponding to each image, identify a frequency of the object keywords based on the number of the identified object keywords, and based on a plurality of keywords corresponding to one image including the same object keywords in multiple times, identify the number of the same object keywords with respect to the one image as one.

5. The electronic device of claim 1, wherein at least one processor, individually and/or collectively, is configured to:
identify whether the user position is a specified position, based on the user position being identified not to be in the specified position, obtain a background keyword of each of the selected plurality of images, determine a background to be reflected on the virtual space of the metaverse based on a frequency of the background keyword corresponding to each of the selected plurality of images, and generate a background content corresponding to the determined background and object contents corresponding to the determined object.

6. The electronic device of claim 1, wherein at least one processor, individually and/or collectively, is configured to:
identify a plurality of texts obtained for a period corresponding to the user position, obtain a plurality of emotion keywords corresponding to the identified plurality of texts, and determine a background to be reflected on the virtual space of the metaverse based on the obtained emotion keyword and the user position.

7. The electronic device of claim 1, wherein the electronic device further comprises a display,
wherein at least one processor, individually and/or collectively, is configured to control the electronic device to:
transmit the object content to a server, receive a virtual space image including the object content from the server, and display the received virtual space image.

8. The electronic device of claim 7, wherein at least one processor, individually and/or collectively, is configured to:
control the display to display a UI to display at least one image corresponding to the object content at positions corresponding to the object content within the virtual space image.

9. The electronic device of claim 1, wherein at least one processor, individually and/or collectively, is configured to:
identify whether the number of a plurality of images corresponding to the user position among the plurality of images is equal to or greater than a specified number, and based on the number of the plurality of images corresponding to the user position among the plurality of images being equal to or greater than the specified number, obtain an object keyword included in each of the selected plurality of images.

10. The electronic device of claim 1, wherein at least one processor, individually and/or collectively, is configured to:
sense the user position in real time, and based on the user position being sensed as being changed from a first position to a second position, select a plurality of images corresponding to the first position among the plurality of images.

11. A method of controlling an electronic device, comprising:
selecting a plurality of images corresponding to a user position among a plurality of images;
obtaining an object keyword included in each of the selected plurality of images;
determining an object to be reflected on a virtual space of metaverse based on a frequency of the object keyword obtained through each of the selected plurality of images; and
generating an object content corresponding to the determined object.

12. The method of claim 11, wherein the determining includes:
identifying a frequency of each of the obtained object keywords and selecting a plurality of first object keywords in which the identified frequency is equal to or greater than a specified value among the plurality of object keywords; and
determining an object to be reflected on the virtual space of the metaverse based on the selected plurality of first object keywords.

13. The method of claim 12, wherein the determining includes:
identifying semantic similarity between the user position and a plurality of first object keywords;
selecting second object keywords having semantic similarity in which the identified semantic similarity is equal to or greater than a specified value among the plurality of first object keywords; and
determining an object to be reflected on the virtual space of the metaverse based on the selected second object keywords.

14. The method of claim 11, wherein the determining includes:
identifying the number of object keywords corresponding to each image, identify a frequency of the object keywords based on the number of the identified object keywords, and based on a plurality of keywords corresponding to one image including a same object keywords in multiple times, identify the number of the same object keywords with respect to the one image as one.

15. A non-transitory computer-readable recording medium storing computer instructions that when executed by at least one processor, comprising processing circuitry, of an electronic device, individually and/or collectively, cause the electronic device to:
select a plurality of images corresponding to a user position among a plurality of images;
obtain an object keyword included in each of the selected plurality of images;
determine an object to be reflected on a virtual space of metaverse based on a frequency of the object keyword obtained through each of the selected plurality of images; and
generate an object content corresponding to the determined object.

16. The non-transitory computer-readable recording medium of claim 15, wherein the computer instructions further cause the electronic device to:
identify a frequency of each of obtained object keywords, select a plurality of first object keywords in which the identified frequency are equal to or greater than a specified value among the plurality of object keywords, and determine an object to be reflected on the virtual space of the metaverse based on the selected plurality of first object keywords.

17. The electronic device of claim 16, wherein the computer instructions further cause the electronic device to:
identify semantic similarity between the user position and the plurality of first object keywords,
select second object keywords having semantic similarity in which the identified semantic similarity is equal to or greater than a specified value among the plurality of first object keywords, and based on the selected second object keywords, determine an object to be reflected on the virtual space of the metaverse.

18. The electronic device of claim 15, wherein the computer instructions further cause the electronic device to:
identify a number of object keywords corresponding to each image, identify a frequency of the object keywords based on the number of the identified object keywords, and based on a plurality of keywords corresponding to one image including the same object keywords in multiple times, identify the number of the same object keywords with respect to the one image as one.

19. The electronic device of claim 15, wherein the computer instructions further cause the electronic device to:
identify whether the user position is a specified position, based on the user position being identified not to be in the specified position, obtain a background keyword of each of the selected plurality of images, determine a background to be reflected on the virtual space of the metaverse based on a frequency of the background keyword corresponding to each of the selected plurality of images, and generate a background content corresponding to the determined background and object contents corresponding to the determined object.

20. The electronic device of claim 15, wherein the computer instructions further cause the electronic device to:
identify a plurality of texts obtained for a period corresponding to the user position, obtain a plurality of emotion keywords corresponding to the identified plurality of texts, and determine a background to be reflected on the virtual space of the metaverse based on the obtained emotion keyword and the user position.
